(19) United States
(12) Patent Application Publication
(10) Pub. No.: US 2017/0072301 A1
(43) Pub. Date: Mar. 16, 2017

(54) Moral Dilemma Movie Game Method

(71) Applicants: Max Abecassis, Boca Raton, FL (US); Ryan M. Donahue, Boynton Beach, FL (US)

(72) Inventors: Max Abecassis, Boca Raton, FL (US); Ryan M. Donahue, Boynton Beach, FL (US)

(73) Assignee: CustomPlay LLC

(21) Appl. No.: 14/856,456

(22) Filed: Sep. 16, 2015

(51) Int. Cl. A63F 9/18; A63F 13/25

(52) U.S. Cl. CPC A63F 9/183; A63F 13/25; A63F 2009/2457

(57) ABSTRACT

Systems and methods for displaying movie related information on a system (e.g., a smartphone, tablet, personal computer, and devices comprising processing, memory, communications, and a display) capable of displaying information and features of an application's movie related functions (e.g., dilemmas, filmmaking, locations, music, plot info, quotes, food recipes, shopping, superfan, trivia, vehicles & weapons identification, and performer/character identification) in each of a plurality of presentation modes (e.g., synchronization, lists, and games modes).

### BACKGROUND OF THE INVENTION

1. Field of the Invention

Systems and methods for displaying movie related information on a system capable of displaying information and features of an application's movie related functions in each of a plurality of presentation modes.

2. Description of the Related Art

Systems for, and methods of, displaying movie related information, whether in synchronization with, or independently, of a playing of a corresponding movie on the same or on a second screen device, are limited in the functions, features, information, and capabilities that are provided to the user. The related art includes, for example, U.S. publication 20130251337 titled “Providing item information during video playing”; U.S. publication 20150037003 titled “Synchronizing A Map To Multiple Video Formats”; U.S. publication 20150037006 titled “Downloading Video Bookmark Generating Data”; U.S. publication 20130343721 titled; “Playing A Video Presentation With Playback Functions”; U.S. publication 20140219630 titled “Video Map Responsive To A Video Release”; U.S. publication 20150086174 titled “Second Screen Dilemma Function”; U.S. publication 20150110458 titled “Second Screen Trivia Function”; and U.S. publication 20150170325 titled “Second Screen Recipes Function”.

### BRIEF SUMMARY OF THE INVENTIONS

The present inventions relate to systems and methods for displaying movie related information on a system (e.g., a remote web server that processes API requests from a user's device, a website server, a smartphone, a tablet, a hybrid, a laptops, and a computing communications device) comprises processing, memory, and communications capabilities required to fully operate the application's various functions and methodologies and capable of displaying information and features of an application's movie related functions (e.g., dilemmas, filmmaking, locations, music, plot info, quotes, food recipes, shopping, superfans, trivia, vehicles & weapons identification, and performer/character identification) in each of a plurality of presentation modes (e.g., synchronization, lists, and games modes).

Accordingly, it is an object of the present inventions to display on a device information items and features of each of a plurality of an application's movie related functions (e.g., dilemmas, filmmaking, locations, music, plot info, quotes, food recipes, shopping, superfans, trivia, vehicles & weapons identification, and performer/character identification) in each of a plurality of presentation modes (e.g., synchronization, lists, and games modes).

It is also an object of the present inventions to synergistically integrate in a device a playing of a movie and the synchronized display of information and/or features of each of a plurality of an application's movie related functions.

It is also an object of the present inventions to, in synchronization with a playing of a movie, to display information and/or features of one of a plurality of an application's functions responsive to either an on-demand function or a notify function.

It is also an object of the present inventions to display shopping information items that are responsive to a user's pre-established preferences for categories of shopping items (e.g., clothing & accessories, electronics & entertainment, home & office, references & unexpected, toys & games, misc, vehicles, and weapons & gear) and subcategories of shopping items (e.g., in the weapons & gear category, subcategories comprises firearms & accessories, futuristic weapons, non-lethal weapons, other weapons & accessories, and tactical gear; and in the references & unexpected category, subcategories comprises references, and unexpected).

It is also an object of the present inventions to display trivia items that are responsive to a user's pre-established preferences for categories of trivia items such as movie questions (e.g., questions relating to a single movie), general questions (e.g., questions relating to general movie knowledge, polls (e.g., movie related polling questions), and write-ups (e.g., presentation of trivia factoids).

It is also an object of the present inventions to provide standardized movie focused games (e.g., movie master, trivia, dilemmas, music, and recipes) for each of a plurality of movies.

It is also an object of the present inventions to provide a movie focused game presenting questions of moral dilemmas depicted within a movie, and identifying a movie character that is most responsive to a user's responses to moral dilemmas questions, and identifying a movie character that is least responsive to the user's responses to moral dilemmas questions.

It is also an object of the present inventions where the identification of a movie character that is most responsive to a user's responses to moral dilemmas questions takes into consideration the most updated set of character profiles as well as a user's combined answers to dilemma games from multiple movies.

It is also an object of the present inventions to provide a movie game comprising a set of questions that are immersed within the context of a single movie and that cover a broad range of entertaining and informative content categories.

It is also an object of the present inventions to introduce to a user the principal features of each of an application's informative and entertaining movie-related functions within the context of a challenging game experience.

It is also an object of the present inventions to provide, within a movie game and following a user's answer to the presentation of a question, information relating to the principal features of each of an application's movie-related functions.

It is also an object of the present inventions to implement in a game's question and multiple answer format a standardizing multi-try scoring methodology.

It is also an object of the present inventions to provide, with respect to a movie game, function specific scoring statistics such as the function name, the number of questions for that function, and the number correct on a first try.

It is also an object of the present inventions to display, within the context of a movie game introducing an application's food recipe movie-related function, a food recipe.

It is also an object of the present inventions to display, within the context of a movie game introducing an application's movie-related functions, a performer's IMDb website page.

It is also an object of the present invention to display, within the context of a movie game introducing an application's locations movie-related function, a street view map and a satellite geographic map of a locale depicted within the movie.

It is also an object of the present inventions to display, within the context of a movie game introducing an application's music movie-related function, a question relating to a musical item played within the movie, the capability to play a portion of the musical item within the context of the question, and to display the availability for purchase of the musical item.

It is also an object of the present inventions to identify a small score sample from one movie that is included in the musical item of another movie.

It is also an object of the present inventions to display, within the context of a movie game introducing an application's movie-related functions, an award that is responsive to a user's score, and to enable the user to post the award to a plurality of social media platforms.

It is also an object of the present inventions to display, a trophy case comprising indications of the awards a user has compiled in each of a plurality of movies.

It is also an object of the present inventions to provide in response to a user's request (e.g., voice recognition of a “Read” command) an audio providing information comparable to information textually displayed.

Briefly, these and other objects are enabled by systems for, and methods of, for example, analyzing a movie to identify item information opportunities, such as locations, trivia, and dilemmas; and creating a movie map comprising notification points in a movie, and movie related information comprising descriptors, write-ups, video frame identifications, and website links to support the applications various functions (e.g., dilemmas, filmmaking, locations, music, plot info, quotes, food recipes, shopping, superfans, trivia, vehicles & weapons identification, and performer/character identification) in each of a plurality of presentation modes (e.g., synchronization, lists, and games modes).

Sync mode provides the opportunity, while viewing the movie, to access the functions via an on-demand or a notification feature. Lists mode provides the opportunity, independently of viewing the movie, to access a list of the items available in each of the functions. Games mode provides the opportunity, independently of viewing the movie, to play dilemma, movie master, trivia, music, and food recipe games.

The application and application databases and images are utilized by and/or downloaded to systems such remote web server that processes API requests from a user's device, a website server, a smartphone, a tablet, a hybrid, a laptops, and a computing communications device comprising processing, memory, communications, and a display. Individual movie maps are utilized as a user specifically requests them. Function features and information are displayed according to the user's selected mode, activated functions, and preferences. For example, in game mode, the Dilemma game comprises displaying a plurality of moral dilemma questions, each of which is associated with a plurality of displayed answers; receiving a user's answer selections in response to the displayed plurality of moral dilemma questions; combining the received user's answer selections with a previously received sets of user's answer selections; comparing the combined user's answer selections against a moral dilemma profile of each of a plurality of movie characters; and identifying, responsive to the comparing, a movie character that is matched to the combined user's answer selections. In a preferred embodiment, the previously received set of user's answer selections was responsive to a set of moral dilemma questions derived from a movie that is different than the movie from which the displayed plurality of moral dilemma questions are derived.

In another example, a Movie Master game comprises a system (e.g., a remote web server that processes API requests from a user's device, a smartphone, a tablet, and a computing communications device) performing the steps of: displaying a movie related question derived from information of a movie related function of a plurality of movie related functions (e.g., dilemmas, filmmaking, locations, music, plot info, quotes, food recipes, shopping, superfans, trivia, vehicles & weapons identification, and performer/character identification) of a movie application, and displaying a plurality of answers associated with the movie related question; displaying, subsequent to receiving a user's answer selection in response to the displayed plurality of answers associated with the movie related question, information from the movie related function; displaying, responsive to a user's request, a subsequent movie related question derived from information of another movie related function of the plurality of movie related functions of the movie application, and displaying a plurality of answers associated with the subsequent movie related question; and displaying, subsequent to receiving a user's answer selection in response to the displayed plurality of answers associated with the subsequent movie related question, information from the another movie related function. Advantageously, in the Movie Master game, the awarding of points is responsive to a number of tries required by the user to select a correct answer from the displayed plurality of answers associated with a movie related question.

These and other embodiments, features, advantages, and objects, are apparent in the context of the detailed description, accompanying drawings, and appended claims that follow. As is detailed below, the present inventions define novel systems and methods that produce useful, new, unexpected, and unpredictable significant results that offer material advantages.

### BRIEF DESCRIPTION OF THE DRAWINGS

The following drawing figures, that form a part of this application, are illustrative of embodiments of the present invention and are not meant to limit the scope of the invention in any manner.

FIG. 1 is an illustration of an application interface enabling the selection of the Sync, Lists, and Games modes;

FIG. 2A is an illustration of an application interface enabling the selection of one of the informational and entertainment functions available in Sync mode;

FIG. 2B is an illustration of an application interface for establishing category preferences in the Shopping function;

FIG. 2C is an illustration of an application interface for establishing preferences in the Trivia function;

FIG. 3 is an illustration of an application interface enabling the selection of one of the informational and entertainment functions available in Lists mode;

FIG. 4 is an illustration of an application interface enabling the selection of one of the informational and entertainment functions available in Games mode;

FIG. 5A is an illustration of an application interface displaying information and features of the Dilemma function in Sync mode;

FIG. 5B is an illustration of an application interface displaying additional features of the Dilemma function in Sync mode;

FIG. 5C is an exemplary illustration of an implementation of the application interface simultaneously playing a movie and displaying information and features of a function;

FIG. 6 is a flow chart of a method of accessing the dilemma function with an apparatus, such as a smartphone, tablet, personal computer, capable of processing information and instructions executable by a processor;

FIG. 7A is an illustration of an application interface displaying information and features of the Dilemma function in Lists mode;

FIG. 7B is an illustration of an application interface displaying information and features of a dilemma question available in Lists mode;

FIG. 8A is an illustration of an application interface displaying information and features of a dilemma available in Dilemma Game mode;

FIG. 8B is an illustration of an application interface displaying information and features of a Dilemma Game;

FIG. 9 is a flow chart of a method of playing a dilemma game on an apparatus, such as a smartphone, tablet, personal computer, capable of processing Information and instructions executable by a processor;

FIG. 10A is an illustration of an application interface displaying information and features of a dilemma question in the Movie Master game;

FIG. 10B is an illustration of an application interface displaying information and features of the Dilemma function within the Movie Master game;

FIG. 11A is an illustration of an application interface displaying information and features of a recipe question in the Movie Master game;

FIG. 11B is an illustration of an application interface displaying information and features of the Recipe function within the Movie Master game;

FIG. 11C is an illustration of an application interface displaying information and features of a character identification question in the Movie Master game;

FIG. 11D is an illustration of an application interface displaying information and features of the Who function within the Movie Master game;

FIG. 12A is an illustration of an application interface displaying information and features of a location question in the Movie Master game;

FIG. 12B is an illustration of an application interface displaying information and features of the Locations function within the Movie Master game;

FIG. 13A is an illustration of an application interface displaying information and features of a SuperFan question in the Movie Master game;

FIG. 13B is an illustration of an application interface displaying information and features of the SuperFan function within the Movie Master game;

FIG. 14A is an illustration of an application interface displaying information and features of a music question in the Movie Master game;

FIG. 14B is an illustration of an application interface displaying information and features of the Music function within the Movie Master game;

FIG. 14C is an illustration of an application interface displaying an alternate format for a music question in the Movie Master game;

FIG. 14D is an illustration of an application interface displaying an additional alternate format for a music question in the Movie Master game;

FIG. 15A is an illustration of an application interface screen displaying the score features of the Movie Master game;

FIG. 15B is an illustration of an application interface screen displaying a pull down menu of the principal broad functions and modes of the application;

FIG. 15C is an illustration of an application interface screen displaying a user's movie related trophy case;

FIG. 15D is an illustration of an application interface screen displaying a user's awards for a movie;

FIG. 16 is a schematic diagram of a communications, systems, and devices infrastructure;

FIG. 17A is an exemplary illustration of an iPhone implementation of the application interface enabling the selection of the Sync, Lists, and Games modes; and

FIG. 17B is an exemplary illustration of an iPhone implementation of the application interface displaying information and features of a dilemma question available in Lists mode.

### DETAILED DESCRIPTION OF THE INVENTIONS

For purposes of the present disclosure, various terms used in the art are defined as follows:

The term “herein” shall mean in the entirety of this specification including drawings, abstract, and claims. The term herein is not limited to the paragraph or section in which it may appear.

The terms “include”, “comprise”, and “contains” do not limit the elements to those listed. By contrast, only the term “consist” limits the elements to those listed.

No conceptual distinction should be drawn from the use of the terms “on”, “at”, or “in” (e.g., no distinction should be drawn from the use of the phrase receiving on, receiving at, or receiving in a device).

No conceptual distinction should be drawn between the use of the terms “and”, “and/or”, or “or”. For example, the scope of the embodiment is not narrowed by the use of the term “and” rather than the use of the terms “and/or”, or “or”. The applicability of the “and/or” concept is not limited to the explicit instances where the terms “and/or” are used. The explicit use of the terms “and/or” serves to underscore the available permutations.

The term “responsive” does not limit the elements, conditions, preferences, and/or requirements that may be taken into consideration. For example, an event that is responsive to a specified requirement is not limited to being responsive to only that specified requirement. An event may be responsive to a specified requirement and may be responsive, although not necessarily, to a second non-specified requirement, specially, when the second requirement, while described as an alternative requirement, may be also deemed complementary.

The terms “application software”, “software application”, “application”, “app”, “routine”, and “computer software” shall mean any one or more executables, libraries, scripts, instructions, and/or processor executable steps in any format that causes, or is required by, a system to perform a task, function, or process. Application software or routines comprises a computer program designed to assist a user to perform task, function, process, or activity. In some instances application software and operating system software may be synergistically integrated and indivisible.

The term “associate” shall mean assign, give, allocate, associate, designate, ascribe, attribute, link, and/or relate.

The term “descriptor” shall mean a keyword, word, term, code, phrase, designations, write-ups, and linkages. The term descriptor shall also mean any information, image, and video-frame that identifies, describes, links, and/or categorizes content of a movie, portions of a movie, or a video-frame. A linkage is any information, data, and method that enables retrieving and/or downloading data from a local/internal and/or a remote/external source.

The term “dialog” shall mean a dialog, conversation, monologue, lyric, utterance, and/or communication. Dialog also comprises information that may be included in the subtitles or the closed captioning.

The term “geographic map” shall mean any map, including satellite, topographical, street, and such maps as Google Maps, Google Earth, Google Earth View, Google Street View, OpenStreetMap, and whether 2D or 3D, static or dynamic and interactive, single or multi-featured, and representative or photorealistic. The term “geographic map” shall also mean any depiction (e.g., map) that provides context for a locale.

The term “information” shall mean information, infotainment, data, descriptors, keywords, linkages, write-ups, and/or features. Information may also mean any content or material that may inform and/or entertain. Information may be provided as text, image, audio, movie, and multimedia content. Information may be factual or fictional.

The term “item” shall mean: (i) an object, article, artifact, instrument, device, and product; (ii) a specific act or action within an activity, process, event, and operation; (iii) an emotion, expression, gesture, and movement; (iv) an effect, consequence, and result; (v) a sound, occasional foreign language, and melodic content; (vi) a portion of a dialog, line, and linguistic expression; (vii) cinematography, cinematographic technique, cinematographic effect, a special effect, technical transition, and production error; (viii) a cameo or special appearance; and (ix) a locale.

The term “keywords” shall mean words, terms, phrases, designations, codes, descriptors, labels, data, metadata, and numbers. The term “keywording” shall mean associating keywords.

The term “locale” shall mean a locale, location, site, setting, place, area, spot, landmark, location of interest, tourist attraction, building, building exterior, building interior, structure, and a geographically identifiable point. A locale is generally a location or place outside of the movie studio that is used for filming a movie or portion of a movie. A locale may be depicted as the actual locale or may be represented in the depictions as a locale other than the actual locale. The term “locale” is differentiated from the term “location” when the term location refers to a point in the timeline of the movie.

The term “movie” shall mean any moving image regardless of the source, motion, or technology implemented. A movie may comprise images and audio found in videos, full motion picture programs, films, movies, interactive electronic games, multi-media content, television programs, commercials, advertisements, and/or entertaining, instructional, and/or educational programming. A typical, but not exclusive, example of a movie is a full length motion picture usually released in theaters and/or optical discs (e.g., a DVD-Movie or Blu-ray Disc). Responsive to the particular embodiment implemented, subtitles, sub picture information, user interface, application software, software program routines, system control codes for controlling the playing of the video/audio, movie map, bookmark instructions, seek/step data, and/or map synchronization data may be provided with a movie.

The terms “movie map”, “map”, and “segment map”, shall mean any combination, arrangement, table, database, listing, index, and/or information that: defines a beginning and ending of one or more segments; identifies one or a plurality of individual video-frames; and/or identifies one or a plurality of play positions in a movie or the audio of a movie. A movie map further comprises information associated with at least: one segment, a sequence of segments, a video-frame, and/or a play positions in a movie or the audio of a movie. A movie map's information may comprise, for example: (i) a descriptor; (ii) an implicit or explicit editing and/or filtering action; (iii) a linkage among segments; (iv) a linkage to an internal/external source of information/content; (v) data, textual, image, audio, and/or movie content; and/or (vi) such information, data, linkages, and content that may required to enable or support the features and functions detailed herein. A movie map may further comprise bookmark generating data, seek/step data, and movie synchronizing information (e.g., an acoustic signature matching database).

The term “noteworthy” in connection with content shall mean content that: (i) may be of interest to a significant audience; (ii) is noteworthy, remarkable, or compelling; and/or (iii) is uncommon, atypical, peculiar, unusual, unique, rare, or extraordinary.

The term “performer” shall mean an individual, participant, actor, or actress, appearing in a movie and/or credited for the physical and/or the verbal performance of a character. A performer refers to, for example, an actor in a movie, an athlete in a televised sporting event, a newscaster in a news program, and a chef in a cooking show.

The terms “play” and “playing”, as in play or playing a segment of a movie, shall mean playing meaningfully, or substantially all or a portion of a segment. In other words, while a method or system disclosed herein may claim or intend to play the entirety of, or all, of a segment, a complete playing of a segment does not necessarily require the playing of every video-frame, interlaced field, audio and sub picture portion, and/or bit of data of the segment.

The term “plot info” shall mean information, rationale, and/or explanation relating to, or relevant to understanding or appreciating, a plot, sub-plot, theme, storyline, principle, idea, key point, clue, and/or item in the movie. The term “plot point” shall mean a plot, sub-plot, theme, storyline, principle, idea, key point, clue, and item.

The term “preferences” shall mean “programming preference”, “version preference”, “presentation preference”, “content preferences”, “function preferences”, “information preferences”, “technical preferences”, and “playback preferences”. The term “programming preference” shall mean a preference or preferences for a specific movie (e.g. Spider-Man), genres of movies (e.g., Action), types of movies (e.g. interactive movie detective games), series of movies (e.g., 007) broad subject matter of movies (e.g. mysteries), and/or time and date for playback of the movie. The term “version preference” shall mean a preference or preferences for a version of a movie (e.g., “Theatrical”, “Unrated”, and “Director's Cut”) released by the copyright owner (e.g., motion picture studio). The version of a movie does not refer to sequels and/or remakes of a movie such as Spider-Man (2002), Spider-Man 2 (2204) and The Amazing Spider-Man (2012). The term “presentation preference” shall mean a preference or preferences that cause the selective inclusion, in a presentation, of segments from within a movie, from a version of a movie, or from within a plurality of movies. The term “presentation preference” shall also mean a preference or preferences for any one of the plurality of features provided by each of the following: Presentations, Compilations, Subjects, Dilemmas, Best Of, Performers, Shopping, Music, Search, and Preview. The term “content preferences” shall mean preferences for the form of expression, explicitness, inclusion or exclusion of objectionable content, a level of explicitness in each of a plurality of content categories of possibly objectionable content, length, level of detail, type of thematic content, and/or depictions of potentially objectionable items, and/or acts. The term “function preference” shall mean a preference or preferences for any one or more of the application functions (e.g., Dilemmas, Filmmaking, Locations, Music, Plot Info, Quotes, Recipes, Shopping, SuperFans, Trivia, Vehicles, Weapons, and Who), function modes, and/or features of one or more functions. The term “information preference” shall mean a preference or preferences for the suitability of a function's information for specific audiences (e.g., seniors, adults, families, teens, children, couples, gamers, beginners, advanced, movie fanatics). The term “technical preference” shall mean a preference or preferences for the technical and/or artistic elements (e.g., dissolves, fades, and wipes) that may be implemented during the playing of non-sequential segments. The term “playback preference” shall mean a preference or preferences for visual and audio options (e.g., camera angles, picture with picture, subtitles, closed captioning, and commentaries) that may be available for a movie.

The term “pre-established” shall mean that the preference, requirement, condition, variable, factor, or element, whether user or system established, is established at a time prior to, and not at the same time as, the application of the preference, requirement, condition, variable, factor, or element.

The term “search terms” shall mean terms, words, phrases, designations, codes, descriptors, labels, data, metadata, numbers, or other information that identifies, describes, or specifies what is being searched.

The terms “segment” and “movie segment” shall mean one or more video-frames. In the example of a feature presentation (e.g., Sixty minutes) a segment definition generally comprises an identification of a beginning and ending points (e.g., frames) within a movie. However, in the examples of second screen function implementations, a segment definition generally identifies a single point (e.g., frame) within a movie.

The term “subtitles” shall mean subtitles, and/or any textual information representative of a portion or portions of a movie's audio dialogue. A display of subtitles does not require a display of all the subtitles of a movie. A display of subtitles may only display a subtitle portion, line, phrase, or unit. Herein, subtitles are materially distinct from closed captioning. The term “subtitle information” shall mean information (e.g., data, text, and/or images) that enables displaying subtitles on a screen. Embodiments that are detailed with respect to the display of subtitles and/or use of subtitle information may be alternatively or complementary display and/or use other supplementary information.

The term “supplementary information” shall mean any information, text, data, depiction, images, movie, and/or content, that informs, entertains, elucidates, illuminates, illustrates, clarifies, and/or explains.

The term “system” shall mean a system, device, apparatus, remote system, remote server, web server, system infrastructure. A system is capable of, independently, or in combination with another system or system infrastructure, communicating, processing, playing, and/or displaying content, e.g., movie, audio, images, subtitles, and/or information. In a system infrastructure, systems such as tablets, smartphones, and mobile devices may be used independently of, or in synergistic communication with, another personal system or commercial system (e.g. remote data or web server). A user's system may perform as a primary screen device and/or a second screen device and comprise, for example, televisions, personal computers, laptop and portable computers, tablets, smartphones, and mobile devices, remote control devices, and computing devices having a display screen.

The term “user” is interchangeable with the terms “subscriber”, “viewer”, and “person”, and shall mean an end-user person actively using movie content, passively viewing a movie, interactively playing a movie game, retrieving movie from a movie provider, and/or actively subscribing to and using multimedia, internet, and/or communication services.

The term “variable content movie” shall mean a movie characterized by a nonlinear architecture facilitating a variety of possible logical sequences of segments. A variable content movie comprises parallel, transitional, and/or overlapping segments to provide multiple versions of a movie. Responsive to the particular embodiment implemented, a variable content movie may also include a user interface, application software, software program routines, system control codes for controlling the playing of the movie/audio, movie map, bookmark generating data, seek/step data, and/or map synchronization data. A movie that does require parallel, transitional, and/or overlapping segments to be variably played.

The term “write-up” is not necessarily limited to the written word. Specifically, in the context of a movie, a write-up may comprise information, video, and/or a multimedia presentation including video and audio (e.g., a video).

The above defined terms and other terms explicitly defined herein are to be understood as defined in this document, and not as they may be defined by incorporation. Incorporation by reference shall not act to modify, limit, or broaden the definitions hereinabove provided or formally defined in this document. A term that is not formally defined in this document is defined herein to have its ordinary and customary meanings.

In a preferred embodiment, a movie related application comprises a set of informative entertaining movie-related functions such as Dilemmas, Filmmaking, Locations, Music, Plot Info, Quotes, Recipes, Shopping, SuperFans, Trivia, Vehicles, Weapons, and Who. Advantageously, the functions are provided in multiple modes, such as, Sync, Lists, and Games. In Sync mode the user is provided the opportunity, while viewing the movie, to access the application's functions of interesting film-related content either on-demand or via a notification feature. In Lists mode the user is provided the opportunity, independently of viewing the movie, to access the application's functions via a list of the items presented for each of the functions. In Games mode the user is provided the opportunity, independently of viewing the movie, to access the application's games, such as the Movie Master, Trivia, Dilemmas, and Music games.

Generally, the information supporting a function's informational and entertainment features comprises, for example, an identification of a location within the movie relating to a depiction of an item, one or a plurality of segment definitions, an identification of a location within the movie to be used by a function's notification feature, a video-frame identifier to provide images and icons, a write-up, supplementary information, information for retrieving, from a local or remote source, supplementary information, an individual's and community ratings, and any other information that a user of the function may deem informative and/or entertaining. While attention is drawn in certain functions to some particular exemplary information items, the information supporting a function is not limited to those specified generally or particularly. Advantageously, information items analogous to those specified in one function may be utilized in a different function.

The Dilemma function provides information relating to the depictions of moral dilemmas within a movie. The disclosures of U.S. patent application publication 20150093093 (the “'093 publication”) with respect to the Dilemmas Second Screen Function (e.g., ¶¶ 133-142 and related FIGS) are incorporated herein by reference.

A moral dilemma usually arises when an individual's decision or action implicates two moral principles that are in conflict with each other, and neither moral principle appears to clearly override the other. Moral principles include, for example, compassion, financial responsibility, obligation to employees, parental responsibility, protection of a loved one, pursuit of soul mate, and self-actualization. In the Spider-Man movie, for example, the character Peter Parker is faced with the decision to either pursue a romantic relationship with Mary-Jane (i.e., Pursuit Of Soul Mate) or sacrifice the potential relationship in order to protect her from his enemies (i.e., Protection Of A Loved One). A moral dilemma is herein referred to as a dilemma, and an agent is the individual facing the dilemma.

The particular information supporting the Dilemmas function's informational and entertainment features comprises, for example, an identification of the location within the movie that depicts a dilemma, a dilemma title, a relationship descriptor, two competing moral principle descriptors, a more detailed identification of the moral principles, a dilemma write-up to provide a recap and an explanation of the specific moral dilemma being depicted, a movie-frame identifying a video frame representative of the depicted dilemma, a generalized moral dilemma question that is subject matter related to the moral dilemma depicted within the movie, information for retrieving from a remote source an in-depth philosophical analysis, a rating, supplementary information, and any other information that a user of the dilemma function may deem informative and/or entertaining.

Generally, the identification of the location of a depiction within a movie may be, for example, the location in which the depiction is introduced, completed, resolved, or, specifically in the case of the Dilemma function, immediately prior to the agent implicitly or explicitly making a decision. The identification of the location may be in the forms of information identifying a video-frame or position in the movie, and/or identifying one or a plurality of movie segments. The latter is advantageous in those instances, e.g., a complex dilemma, where the elements are not present in a contiguous segment or scene. Also generally, a write-up or video presentation should be brief to enhance, rather than detract, from a conventional movie playback experience.

The dilemma relationship descriptor is one of a number of possible descriptors that categorizes the social relationship of the agent, e.g., Spouse/Romantic Partner, Parent/Child, Family, Social Relationships, Government, Business/Profession, and Inner Self To facilitate search across a plurality of movies, the relationship descriptors and the moral principle descriptors are advantageously standardized as descriptors of a few words. In the Spider-Man 2 example, the relationship descriptor is “Spouse/Romantic Partner” and the two moral principle descriptors are “Pursuit Of Soul Mate” and “Protection Of A Loved One”.

The Filmmaking function provides cinematic technical information and explanation on how a scene, clip, or segment was created. The Filmmaking function is principally dedicated to cinematography as art and as technique. The disclosures of the '093 publication with respect to the Filmmaking Second Screen Function (e.g., ¶¶ 127-132 and related FIGS) are incorporated herein by reference.

The information supporting the Filmmaking function's informational and entertainment features comprises, for example, a segment definition (e.g., frame identifier); a write-up to provide, for example, an in-video explanation of how the shot, clip, or scene was filmed/created; a linkage to more detailed technical information, and a linkage to movie specific information. Filmmaking information may also include a playable clip of the sequence from the movie, a playable video from behind the scenes, production photos and other pictorial material, playable audio track from the director's commentary, information for retrieving, from a remote source, supplementary information, and any other information that a user of the Filmmaking function may deem informative and/or entertaining.

The Locations function provides information relating to locales depicted within a movie. The disclosures of the '093 publication with respect to the Locations Second Screen Function (e.g., ¶¶ 110-120 and related FIGS) are incorporated herein by reference.

The information supporting the Locations function's informational and entertainment features comprises, for example, an identification of the location within the movie that depicts a locale; an identity of the locale as represented in the movie, an actual identity of the locale, information for retrieving, from a remote source, an interactive geographic map tat is responsive to the actual locale, the type of geographic map, magnification, orientation, and such other parameters as the provider of the geographic map's API may require; a video-frame identifier to provide a reference image and thumbnail, a write-up to provide brief in-video information, and information for retrieving, from a remote source, supplementary information. Such supplementary information may comprise, for example, a menu in the case of the locale being depicted being a restaurant.

Advantageously, the Locations function information in synergistic combination with an identification of the devices present location enables notifying the user of a nearby filmed location and displaying movie related information. The later taking advantage of the information associated with other of the applications features e.g., Trivia information associated with the scene.

The Music function provides information relating to musical items in a movie, including: songs, score, themes, instrumentals, and ringtones. Innovatively, the Music function also identifies a small score sample from one movie that is included in the musical item of another movie. For example, in the movie Ted, the iconic score from the movie Indiana Jones is incorporated in the score used in a scene in the movie Ted when he escapes. The information supporting the Music function's informational and entertainment features comprises, for example, a song title, artist, album, album art, release year, information for retrieving supplementary information and/or purchase information from a remote source. The supplementary information comprises, for example, artist tour dates, ticket purchases, album/band images, and band bios. An advantageous feature of the Music function is an efficient methodology that facilitates the purchase of musical items within the context of a playing of a movie.

The Plot Info function provides plot information, rationale, or explanation. An advantageous feature of the Plot Info function is to bring attention to certain clues as they occur in the movie. Clues are easily-missed items or moments that are important to obtaining a complete understanding of a movie. The Plot Info explanation for a clue draws the viewer's attention to an important item depicted within the movie. The Plot Info function may also provide an explanation of a character's motivations, recaps from previous movies in a series, and post-credit alerts. The disclosures of the '093 publication with respect to the Plot Info Second Screen Function (e.g., ¶¶ 121-126 and related FIGS) are incorporated herein by reference.

The information supporting the Plot Info function's informational and entertainment features comprises, for example, an identification of a location within the movie to be used to notify the user that Plot Info information is available; an explanation for a plot point, theme, and item depicted within the movie, a write-up, links to blogs and forums that discuss a particular plot point, on-point interview videos with the cast and crew, and information for retrieving, from a remote source, supplementary information.

Advantageously, the information supporting the Plot Info function categorizes the information (e.g., Recap, Plot Info, Clues, and After The Credits) to enable the user to establish a preference for the types of information to be provided. For example, a user may prefer to receive information categorizes as plot information or explanation, but not receive information relating to clues. Alternatively, for example, a user may prefer to only be notified in the event that there is content during or after the credits.

The Quotes function provides access to noteworthy dialog of a movie. A Meme style presentation of text and an image from the movie are displayed for the user to save, rate, and share on social media. The information supporting the Quotes function's informational and entertainment features comprises, for example, an identification of a location within the movie that is associated with the immediately ending quotable dialog, the dialog text, a video-frame identifier to serve as the meme image, reference image, and/or thumbnail. The disclosures of the '093 publication with respect to Ratings Second Screen Function (e.g., ¶¶ 197-202 and related FIGS) are incorporated herein by reference.

The Recipes function provides a drink and food recipes relating to a depiction within a movie. The recipe may be directly related to a drink or food being depicted in a segment within the movie. Alternatively, a drink and/or food recipe may be inspired by a depiction within the movie or a movie's theme. The thematic idea, whether general to the movie or specific to a scene, need not be based on the depiction of a drink/food item or a drink/food theme.

The information supporting the Recipe function's informational and entertainment features comprises, for example, a recipe title; a recipe description; a recipe image (e.g., an image, photograph, illustration, and/or other visual representation) specifically produced to illustrate a prepared recipe; a recipe ingredient list; a recipe directions; a recipe write-up associating a recipe with a depiction within the movie (e.g., a paragraph describing the association between the recipe and the specific depiction); a quote from within the movie (e.g., a line of dialogue); and a video frame from within the movie (e.g., a video frame representative of the depiction within the movie that is associated with the recipe). Advantageously, the information supporting the Recipe function may further comprise additional movie specific data and pictures, as well as links to additional movie data, recipe sources, and shopping opportunities. The disclosures of U.S. patent application publication 20150170325 (the “'325 publication”) with respect to the Second Screen Recipes Function (e.g., ¶¶ 183-196 and related FIGS) are incorporated herein by reference.

The Recipe function's information may also comprise information for facilitating the purchase of items relating to a recipe. Purchase items comprise items included in a recipe's list of ingredients; decorative items, glassware, and dishware included in the photograph; and special equipment used in the preparation of the recipe. An advantageous feature of the Recipe function is an efficient methodology that facilitates the purchase of recipe related items within the context of a playing of a movie.

The Shopping function provides information relating to purchasable items depicted within the movie. The information supporting the Shopping function's informational and entertainment features comprises, for example, an identification of the depicted item, an identification of a purchase item related to the depicted item, and information for retrieving, from a remote source, purchase information. The disclosures of the '093 publication with respect to Shopping Second Screen Function (e.g., ¶¶ 167-183 and related FIGS) are incorporated herein by reference. An advantageous feature of the Shopping function is an efficient methodology that facilitates the purchase of noteworthy items within the context of a playing of a movie.

Identification information comprises, for example, a name, brand, make, model, image of the depicted item, image of the purchasable item, an identification of the manufacturer/retailer, and an identification of the character depicted within the movie and associated with the purchasable item. Additional information comprises information for the purchase of an alternative item and lowest price comparisons. Additional shopping features include a save for later button, and social media and sharing features.

Advantageously, the information supporting the Shopping function's features comprises an identification of a subcategory appropriate for the item or service. A subordinate, secondary, sub-category, and child categories is a division of, and is associated with, a parent category. The principal, main, primary, or parent categories comprise, for example, Clothing & Accessories, Electronics & Entertainment, Home & Office, Toys & Games, Misc, Vehicles, and Weapons & Gear. In other words subcategories drill down from a main category. For example, in the Weapons & Gear category, subcategories may comprise Firearms & Accessories, Futuristic Weapons, Non-Lethal Weapons, Other Weapons & Accessories, and Tactical Gear. A Shopping category preference function enables a user to establish a preference for only those categories and subcategories of shopping items of interest to the user.

Advantageously, the information supporting the Shopping function's features are responsive to information preferences, marketing, and audience targeting objectives. For example, identification of a purchase item related to the depicted item is associated with a specific audience (e.g., seniors, adults, families, teens, children, couples, gamers, movie fanatics). Thus, for example, irrespective of a user's product category preferences, a product intended or suitable for one audience (e.g., seniors) would not be presented to an unsuitable audience (e.g., children).

The SuperFan function provides information relating to the depictions, within a movie, of the following four categories of items: Easter eggs, production errors, hidden items, and cameos. The subject matter covered by the SuperFan function is conceptually distinguished from the type of trivia subject matter covered by the Trivia function. In Sync mode, the presentation of the information associated with the SuperFan function requires notification prior to the depiction of the corresponding content during the playing of the movie. As indicated above, generally each function comprises an identification of a location within the movie to be used by a function's notification feature. While in most instances, the notification of an item follows the depiction of the related content, in the case of the SuperFan function, the notification of an item precedes the depiction of the related content. Therefore, unlike the Trivia function, the SuperFan function is a spoiler that provides the information prior to the playing of the related depiction, and it is intended for users that have previously viewed the motion picture or who are not concerned.

The information supporting the SuperFan function's informational and entertainment features additionally comprises, for example, a title, write-up, and information for retrieving, from a remote source, supplementary information. In the Lists mode, the SuperFan function provides access to a replay of the segment relating to the SuperFan item and/or the playing of supplementary videos retrieved from a source other than the movie. As in the case of the Shopping function, a category listing (e.g., Easter eggs, production errors, hidden items, and cameos) enables the user to establish a preference for the notification, within the playing of the movie, of only those items of interest to the user.

The Trivia function provides information relating to the depictions, within a movie, of trivia items. Specifically, the Trivia function provides movie specific trivia questions and corresponding sets of multiple choice answers. Unlike general movie related trivia games, in a preferred embodiment, the trivia questions provided for a movie relate to that movie, and the movie itself provides (directly or indirectly, explicitly or implicitly, prominently or inconspicuously) the information necessary to correctly answer the questions. Advantageously, the Trivia function may comprise polling questions relating to the movie. The disclosures of the '093 publication with respect to Trivia, Info, and Identification Second Screen Functions (e.g., ¶¶ 143-166 and related FIGS) are incorporated herein by reference.

The Trivia function preferences enable the options to include/exclude the presentation of movie questions (e.g., questions relating to the current movie); include/exclude the presentation of general questions (e.g., questions relating to general movie knowledge, or relating to subject matter extraneous to the current movie); include/exclude the presentation of movie related polling questions; and to include/exclude the presentation of write-ups (e.g., trivia factoids). In the movie Frozen, an example of a movie question is: “In the song Let It Go, what does Else say never bothered her anyway? and the corresponding answers are: “The snow”, “The cold”, “The winter”, and “The solitude”. An example of a general question is: “What was the first Disney 3D movie ever released?” and the corresponding answers are: “The Nightmare Before Christmas”, “Chicken Little”, “Meet the Robinsons”, and “Hanna Montana & Miley Cyrus: Best of Both Worlds Concert”. An example of a poll question is: “Which of these modern Disney Princesses is your favorite?” and the corresponding answers are: “Elsa—Frozen”, “Merida—Brave”, “Belle—Beauty And The Beast”, and “Ariel—The Little Mermaid”. An example of a write-up is: “Olaf dancing in a boater hat with the seagulls is an homage to Mary Poppins, when Dick Van Dyke's character, Bert, dances with the penguins.”

The information supporting the Trivia function's informational and entertainment features comprises, for example, a question, a set of possible answers, an image from the movie displayable with the question, an image relating to the correct answer for the question, a write-up explaining a correct answer, comparable user percentages for each answer, polling questions, and information categorizing the questions and write-ups (e.g., questions relating to subject matter extraneous to the movie, polling questions, questions requiring Sync mode, write-ups that can be presented without the presentation of the related questions). A movie's plurality of trivia questions comprise questions that relate to the substantially synchronized depiction of content from within the movie. These depiction dependent questions are intended to be presented in Sync mode and may not be entirely suitable for the Games mode of the application, and thus would be excluded from the Trivia game in the Games mode.

The Vehicle function provides information relating to the depictions, within a movie, of land, air, and sea vehicles. The Weapons function provides information relating to the depictions, within a movie, of real, fictional, and modified weapons.

The information supporting the Vehicles and Weapons functions' informational and entertainment features comprises, for example, an identification of the depicted item, and information for retrieving information from a remote source, e.g., Wikipedia. Identification information comprises, for example, a name, brand, make, model, image of the depicted item, and an identification of the manufacturer. Advantageously, in a preferred embodiment, the Vehicles and Weapons functions' also synergistically utilize the information, and provide the features, of the Shopping function.

The Who function provides information relating to the identification of the characters depicted within the movie and the corresponding performers. The information supporting the Who function's informational and entertainment features comprises, for example, a performer name, character name, performer picture, character picture, and information for retrieving information from a remote source, e.g., IMDb, Wikipedia, and an official fan site. The remote source, specially in the case of a fan cite, provides, for example, a performer's filmography, age, bio, latest news, images, and a method for communicating with a performer. Advantageously, the remote sources also make available trailers of recent movies featuring the identified performer.

In a preferred embodiment, the character picture is a video-frame, from within the movie, that best depicts the character, usually, but not necessarily, a close-up, 2-T, or portrait shot. In certain situations, the video-frame is cropped to maximize the presentation of the character for purposes of facilitating a user's visual recognition of the character. The identification of characters depicted in a movie also comprises the identification of non-human characters, including, for example, animals, monsters, animations, and robots (e.g., Jabba the Hut, Chewbacca, R2-D2). The identification of non-human characters comprises, when available, for example, a character's name or identification, specific biological identification, and model number.

The information and methodologies supporting the Who function's informational and entertainment features comprises, for example, the information and methodologies disclosed in U.S. Pat. No. 8,494,346 (the “'346 patent”) titled: “Identifying A Performer During A Playing Of A Video”, which is incorporated herein by reference.

In a preferred embodiment, the information supporting the Who function's informational and entertainment features comprises associating a video-frame within the movie with a first appearance of a first character; associating subsequent video-frames within the movie with the appearances of subsequent characters; and associating a subsequent video-frame within the movie with a subsequent appearance of the first character. By contrast to a methodology that associates characters with a scene, clip, or segment, the ordered movie-frame interleaving of the association of characters within a scene, clip, or segment, improve the ordered identification of the most recently depicted characters in response to a user's on-demand request during movie playback. The sequence of identified characters is more responsive to their actual appearance in the movie timeline. An additional and material advantage is that the association of a character at the video-frame level rather than at the scene, clip, or segment level avoids identifying characters within a scene, clip, or segment, prior to their appearance. As opposed to a methodology that rigorously identifies each character in each video frame through, for example, face recognition technology, this methodology permits maximizing the efficiency and suitability of a manual process.

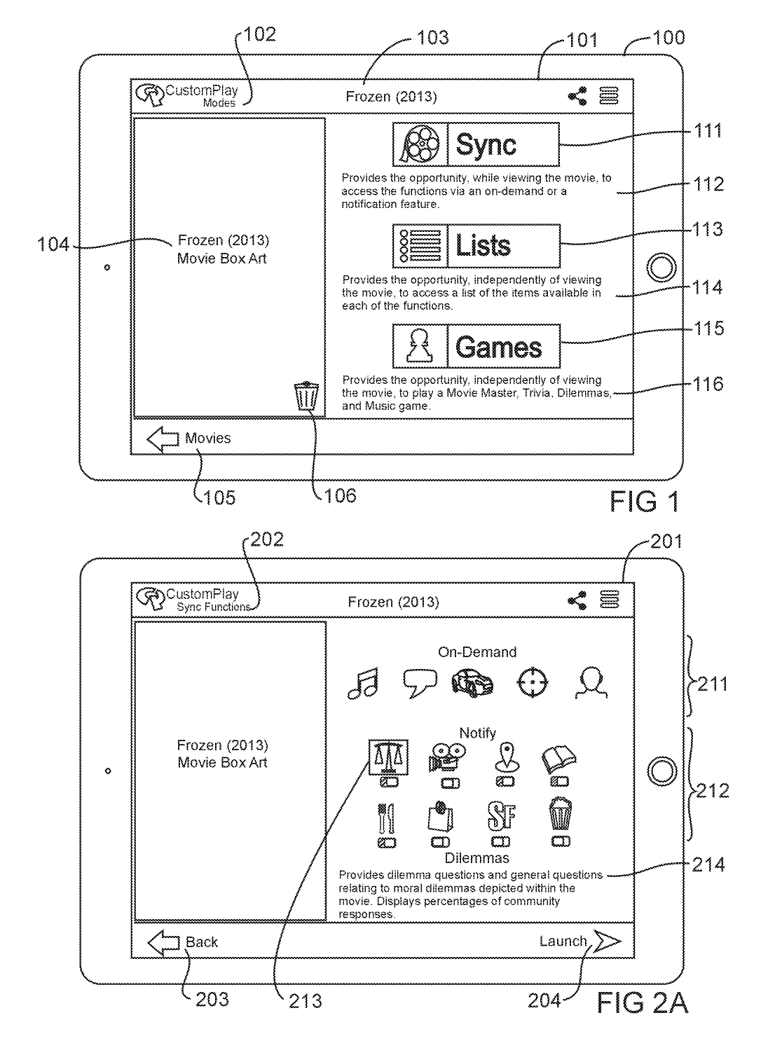

FIG. 1 is an illustration of an application interface enabling the selection of the Sync, Lists, and Games modes. The application modes provide for multiple methods of accessing of the various movie related informational and entertainment functions. In this particular exemplary embodiment, the application is downloaded and installed on an iPad device 100. Together with the application information, data, databases, and images supporting, for example, non-movie specific functions are also downloaded. This includes, for example, the character database and images to support the Dilemmas game matching of a character to a user's responses to the Dilemma game questions.

The modes interface screen 101 identifies the Mode selection as the active function 102, identifies the title of the movie 103 (e.g., Frozen), provides other movie related information, e.g., the release year, and displays the movie box art 104. Following a selection of a movie (e.g., Frozen) on a previous movie selection screen, for which information is desired, and the subsequent downloading of the corresponding movie map, this subsequent exemplary interface 101 displays a selection button for the Sync mode 111, the Lists mode 113, and the Games mode 115. The interface 101 explains that the Sync mode 111 “Provides the opportunity, while viewing the movie, to access the functions via an on-demand or a notification feature.” 112; the Lists mode 113 “Provides the opportunity, independently of viewing the movie, to access a list of the items available in each of the functions.” 114; and that the Games mode 115 “Provides the opportunity, independently of viewing the movie, to play a Movie Master, Trivia, Dilemmas, and Music game.” 116. The interface screen 101 also enables returning to the movies' map selection screen 105 and deleting the current movie map 106.

The Sync mode is dependent on establishing substantial synchronization between a playing of a movie and a written, visual, and/or audio display/presentation of information. With respect to movie playback functions and movie synchronization, the disclosures of U.S. patent publication 20150037006 titled “Downloading Video Bookmark Generating Data” (the “'006 publication”) are incorporated herein by reference; and with respect to identifying a particular release of a movie in order to retrieve and apply the appropriate movie map, the disclosures of U.S. patent publication 20140219630 titled “Video Map Responsive To A Video Release” (the “'630 publication”) relating to a Video Maps Responsive to Video Releases ¶¶ 0269-0284 are additionally incorporated herein by reference. Those references and the references cited therein are foundational to movie synchronization and are incorporated herein by reference.

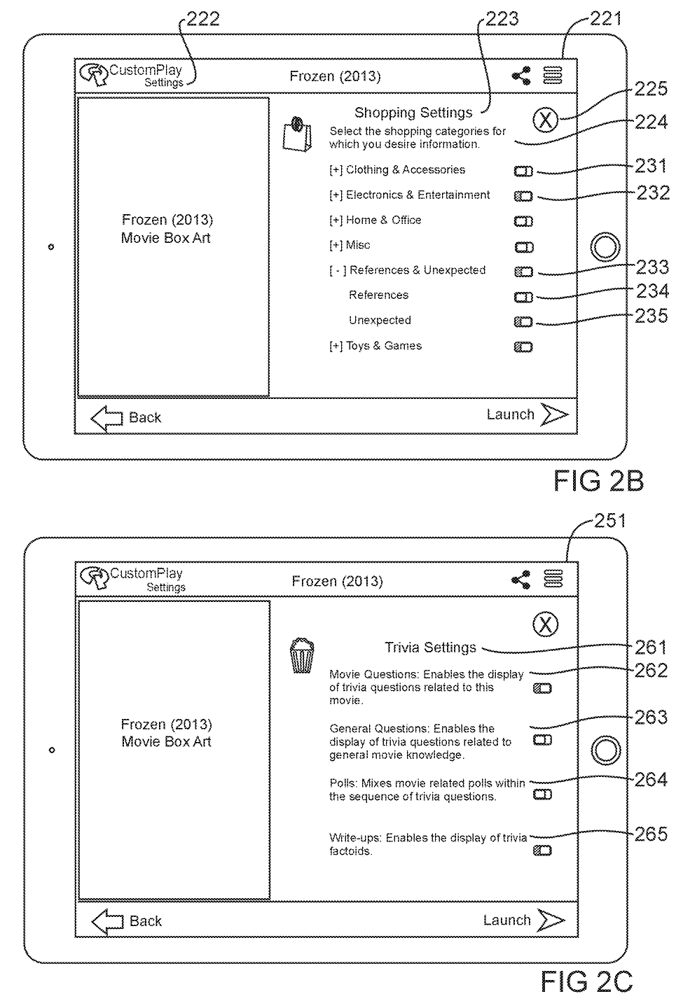

FIG. 2A is an illustration of an application interface enabling the selection of one of the informational and entertainment functions available in Sync mode. This interface screen 201 identifies the Sync functions selection as the active function 202. In Sync mode the user is provided the opportunity, while viewing the movie, to access the application's functions of interesting film-related content either on-demand 211 or via a notification feature 212. The Sync on-demand functions 211 comprise (left to right) the Music, Quotes, Vehicles, Weapons, and Who functions. The Sync notify functions 212 comprise (left to right) the Dilemmas 213, Filmmaking, Locations, Plot Info, Recipes, Shopping, SuperFans, and Trivia functions. In this particular illustration, the notify features have been enabled, by means of an on/off toggle slide, for the Dilemmas 213, Locations, Plot Info, and Recipe functions. Selecting a function icon 213 enabled the display of a write-up 214 describing the function. A back icon 203 enables returning to the Modes screen. A Launch icon 204 launches, during movie playback, the synchronized access of the on-demand functions and the synchronized notification of the enabled notify functions.

FIG. 2B is an illustration of an application interface for establishing category preferences in the Shopping function. The screen 221 enables a user to establish a preference for only those categories and subcategories of shopping items of interest to the user. This function is particularly advantageous in Sync mode since it minimizes unwelcomed notifications during a playing of a movie. This interface screen 221 identifies the Settings function as the active function 222, identifies that the settings are for the Shopping function 223, provides instructions 224 (e.g., “Select the shopping categories for which you desire information.”), and provides an icon button to exit 224 the Shopping Settings function. The principal object of the Shopping Settings function is to enable a user to establish a preference for only those categories and subcategories of shopping items of interest to the user.

A shopping category preference feature of the Shopping function enables a user to establish a preference for only those categories and subcategories of shopping items of interest to the user. A category and subcategory structure supports an elegant display methodology that facilitates an extensive shopping preference structure. A user may select to include/exclude an entire category or select to individually include/exclude subcategories within a category. For example, in the illustration, a user has elected to exclude all the subcategories in the Clothing & Accessories category 231, while including all subcategories in the Electronics & Entertainment category 232. Innovatively and advantageously, in addition to the conventional shopping categories such as Clothing & Accessories, the shopping categories additionally comprise a References & Unexpected category 233, a References subcategory 234 and an Unexpected subcategory 235. Deselecting a category causes the exclusion of all the items in the underlying subcategories without altering their individual include/exclude settings. This provides an efficient method of temporarily disabling a category of shopping items without affecting subcategory settings for a future use.

A References subcategory 234 provides access to items that are related to a depiction that makes a reference to or pays homage to an item external to the movie. Often the depiction is in the form of a dialog reference. For example, in the movie Forrest Gump, the characters Forrest and Lt. Dan are crossing a busy New York City street while “Everybody's Talkin'” by Harry Nilsson is playing. After nearly being hit by a taxi, Lt. Dan yells, “Hey, I'm walking here!” This dialog is a Reference to the movie Midnight Cowboy. The shopping function associates the reference “Hey, I'm walking here!” with the sale of the Blu-ray disc of the movie Midnight Cowboy.

An Unexpected subcategory 235 provides access to items that are not explicit or obvious in the depiction within the movie. For example, in the movie Frozen an Unexpected item is a karaoke machine that is associated with the scene in which the song “Let It Go” is sang by the character Elsa. Often the association of the depiction within the movie and an Unexpected subcategory item is intended to surprise, amuse, or entertain. The sale of the item is of minimal if any priority. Items categorized in the References subcategory 234 or in the Unexpected subcategory 235, are also categorized in the appropriate conventional subcategory. For example, in the case of the Midnight Cowboy Blu-ray disc, the item is also categorized in the Media subcategory within the Electronics & Entertainment category 232.

FIG. 2C is an illustration of an application interface for establishing preferences in the Trivia function. The screen 251 enables a user to establish a preference for the display of only those trivia categories of interest to the user. This interface screen 251 identifies that the settings are for the Trivia function 261, provides an explanation of each of the trivia categories (e.g., Movie Questions, General Questions, Polls, and Write-ups). For example, “Movie Questions: Enables the display of trivia questions related to this movie.” 262, “General Questions: Enables the display of trivia questions related to general movie knowledge.” 263, “Polls: Mixes movie related polls within the sequence of trivia questions.” 264, and “Write-ups: Enables the display of trivia factoids.” 265. In the illustration, a user has elected to include trivia questions relating to the movie Frozen, include write-ups, exclude questions relating to general movie knowledge, and exclude participating in polls. An example of a poll associated with the movie Frozen is: “Which is your favorite Disney Princess?” The four options provided the user are: “Elsa from Frozen”, “Belle from Beauty and the Beast”, “Cinderella From Cinderella”, and “Ariel from Little Mermaid”.

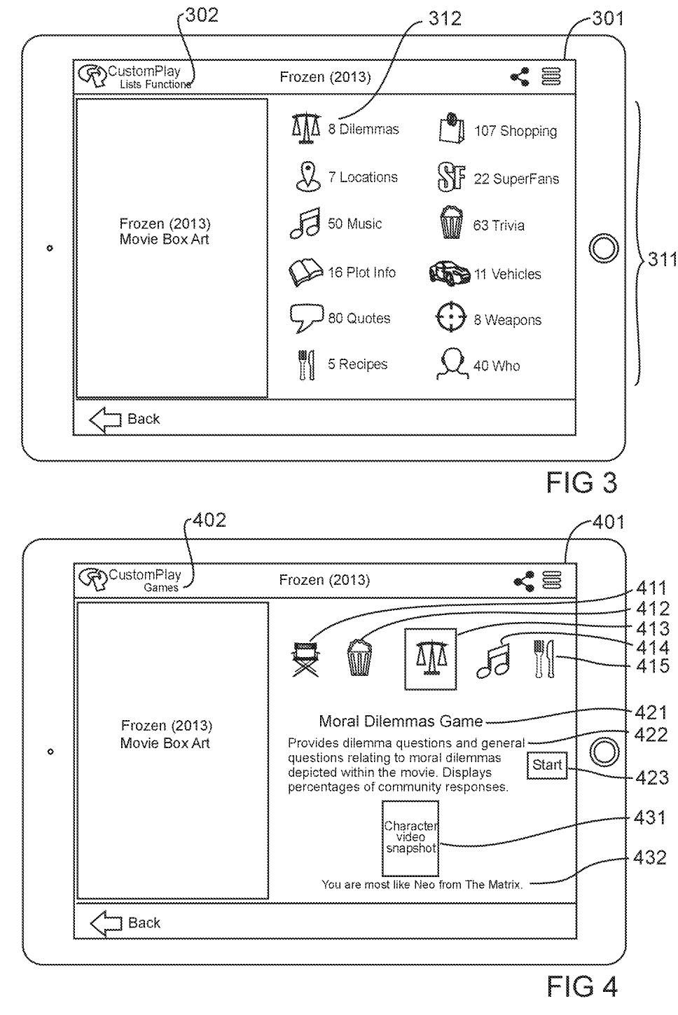

FIG. 3 is an illustration of an application interface enabling the selection of one of the informational and entertainment functions available in Lists mode. This interface screen 301 identifies the Lists functions selection as the active function 302. In Lists mode the user is provided the opportunity, independently of viewing the movie, to access the application's functions 311 via a list of the items available for each of the functions. In the example of FIG. 3, the number of items available in each function for the selected movie are displayed (e.g., 8 Dilemmas) 312.

FIG. 4 is an illustration of an application interface enabling the selection of one of the informational and entertainment functions available in Games mode. This interface screen 401 identifies the Games selection as the active function 402. In Games mode the user is provided the opportunity, independently of viewing the movie, to play any of the games. In the example of FIG. 4, the available games are Movie Master 411, Trivia 412, Dilemmas 413, Music 414, and Recipes 415. Selecting an icon 413 causes the display of game identification 421, such as a title, and a write-up 422 describing the game. A start button 423 enables the playing of the selected game 413. In the event that a selected game was previously played, a trophy, award, score, and/or information are displayed. In the case of the Dilemmas game 413, the information comprises a character video/snapshot 431 and a write-up 432 (e.g., “You are most like Neo from The Matrix.”) The awarding of these items is detailed further below.

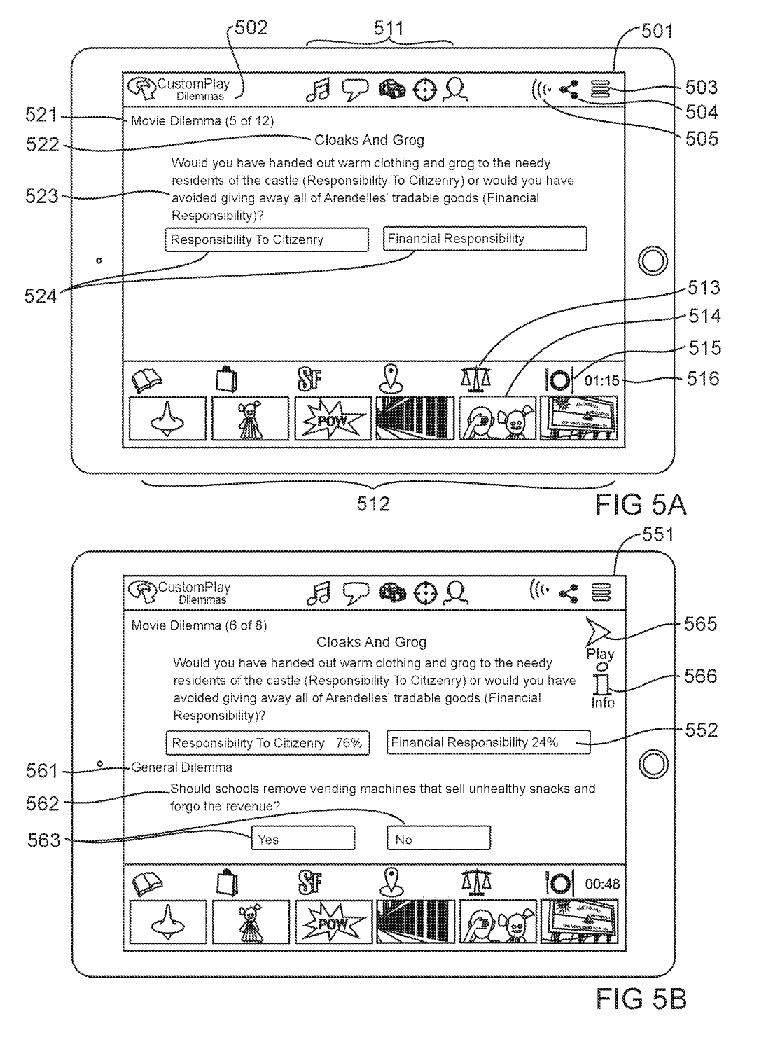

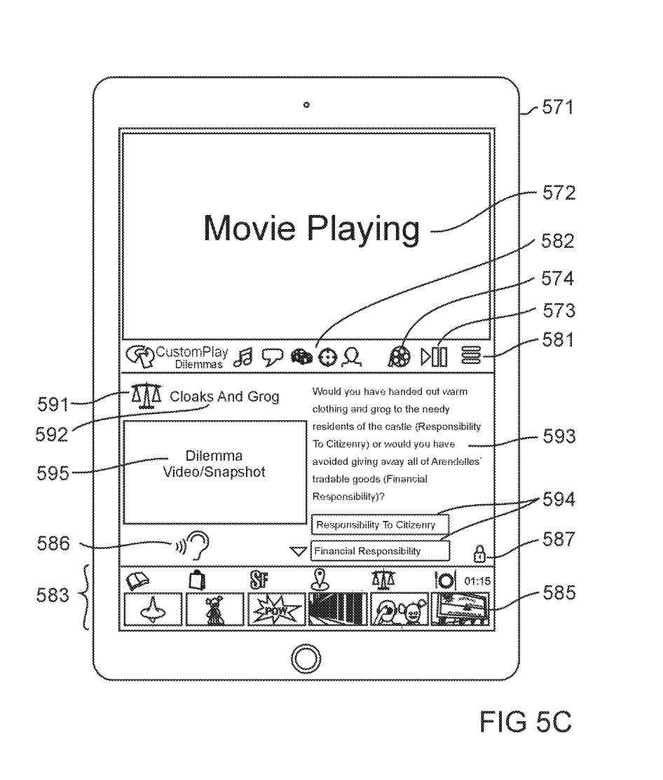

FIG. 5A is an illustration of an application interface displaying information and features of the Dilemma function in Sync mode. This interface screen 501 identifies Dilemmas as the active function 502. The function identification 502 is contemporaneously updated with the display or activation of features of a function, in this example, the display of the Movie Dilemma question. A pull down menu icon button 503 provides access to the functions of the application such as, movie maps selection, the Sync mode, the Lists mode, the Games mode, social sharing, awards, alerts configuration, preferences and settings. A sharing icon button 504 enables social media posting and email functions. A sync icon button 505 displays the status of movie sync routines (e.g., in sync or syncing), as well as user activation of re-sync routines.

The exemplary embodiment illustrated in FIG. 5A comprises icon buttons 511 to enable the on-demand functions (left to right) Music, Quotes, Vehicles, Weapons, and Who. The exemplary embodiment also comprises a timeline organized display of multiple function notifications 512 utilizing, for example, an icon representing a function 513, and an image (video frame) 514 extracted from within the movie. In this particular embodiment, responsive to the current movie play position and the movie map, a function icon (e.g., Dilemma icon) 513 is used to identify a notification of the availability of content related to the corresponding function (e.g., Dilemma). Advantageously a video frame 514 within the movie and responsive to the function and current play position is also displayed to assist in visual recognition.

The notification of a most current function (e.g., Recipes function identification icon and video frame 515) shifts previous notifications 513-514 to the left. The point within the movie that the notification and display of the function features are provided may be responsive to a notification point that is specified for the particular item, and may be the same or different from the video frame related to the actual depiction. Alternatively, the notification point may be responsive to a system/user pre-established relationship to the video frame related to the depiction, or responsive to the location of a related dialog. Also, illustrated is an indication 516 of the time (e.g., one minute 15 seconds) to the next function notification.

In the exemplary embodiment illustrated in FIG. 5A, the display of the features of the Dilemma function in Sync mode comprises an identification that the moral dilemma question relates to a depiction within the movie 521 (e.g., “Movie Dilemma (5 Of 8)”), a title 522 for a moral dilemma depicted within the movie (e.g., “Cloaks And Grog”), a moral dilemma question identifying the two moral principles that are in conflict 523 (e.g., “Would you have handed out warm clothing and grog to the needy residents of the castle (Responsibility To Citizenry) or would you have avoided giving away all of Arendelles' tradable goods (Financial Responsibility)?”), and two moral principle labeled buttons 524 for a user to select a choice (e.g., “Responsibility To Citizenry, and Financial Responsibility”).

In an alternate embodiment, rather than displaying the two moral principle labeled buttons 524, the user is presented with two drop-down lists each displaying a set of moral principle descriptors from which the user may select what they believe to be the appropriate moral principles implicated by the recently depicted moral dilemma. In the event that a write-up is included, the moral dilemma question would not include the explicit identification of the moral principle descriptors (e.g., “Would you have handed out warm clothing and grog to the needy residents of the castle or would you have avoided giving away all of Arendelles' tradable goods?”) The set of moral principles descriptors may be a subset selected from a wider set of moral principles descriptors. The subset is chosen for applicability and ease of distinction (e.g. reduce similar moral principles). Once the user has selected two moral principle descriptors, the application now displays the two moral principles descriptors 524 determined to be most applicable to the moral dilemma. The descriptors determined to be most applicable may be responsive to, for example, expert evaluation and/or community responses.

Features of the Dilemma function may also comprise displaying a relationship descriptor relating to the depicted dilemma. A relationship descriptor is one of a number of possible descriptors that categorizes the social relationship of the agent (e.g., Spouse/Romantic Partner, Parent/Child, Family, Social Relationships, Government, Business/Profession, and Inner Self). Other features may enables a user to selectively search other moral dilemma depictions matching, individually or in combination, a relationship descriptor, a first moral principle descriptor, and/or a second moral principle descriptor. To facilitate the search, drop-down lists are provided for each field. In this example, Boolean capabilities are included by toggling a search box to indicate an exclude condition (an X mark), the include condition (a check mark), or a do not consider condition (a blank box). Alternatively, since in one embodiment the default condition is a match, the user may automatically search for instances of a dilemma having the same moral principles in conflict.

In a preferred embodiment, responsive to user's pre-established or contemporaneously established preference, and during a playing of the movie on a primary screen and before the outcome of a dilemma is depicted, immediately after a Dilemma has been displayed on a second screen, the playing of the movie is paused. Once the user activate the resume playing of the movie, the playing of the movie on the primary screen is automatically resumed at a suitable point prior to the location in which the movie was paused in order to assist the user in recollecting the relevant details and context of the movie at the time it was paused.

FIG. 5B is an illustration of an application interface displaying additional features of the Dilemma function in Sync mode. This interface screen 551 depicts features of the Dilemma function following a user selection of either moral principle in response to the movie dilemma question. In an embodiment where data is accumulated for other user's responses, the aggregated community responses are displayed 552 (e.g., “Responsibility To Citizenry 76%, and Financial Responsibility 24%)”.

Advantageously, features of the Dilemma function further comprise the display of an additional dilemma question. In this exemplary embodiment, the additional dilemma question is a general dilemma question 561 that relates to the moral principles of the corresponding movie dilemma but attempts to introduce a different perspective, real-world applicability, and/or entertainment value. In this particular embodiment the general dilemma question 562 is drafted in a manner that elicits from the user a yes or no answer 563 (e.g., “Should schools remove vending machines that sell unhealthy snacks and forgo the revenue?”). As in the case with the movie dilemma, following a user response, the aggregated community responses are displayed.

Information supporting the Dilemma function may also comprise an identification of the segment or segments from within the movie that provide context for the two moral principles that are in conflict in each corresponding moral dilemma, a more detailed identification of the moral principles, information (e.g., linkages) to internal or external information or discussion, a rating, and/or any other information that a user of the Dilemma function may deem informative and/or entertaining. For example, a play dilemma feature 565 causes the automatic playing of a segment or segments from within the movie that provide context for the two moral principles that are in conflict in a dilemma. In a preferred second screen embodiment, a dilemma replay feature 565 enables, for example, a replaying on the primary screen of the various previously played segments of the movie that precede the decision point and that assist the user in recollecting the relevant details and context of a dilemma. This is particularly advantageous in those instances where the depiction of one of the two moral principles is much earlier in the movie that the current play position. Further, an info dilemma feature 566 provides access to internal or external additional information relating to the implicated moral principles and the depicted moral dilemma as may be provided by, for example, the application's website; an in-depth philosophical analysis as may be provided by, for example, a fan website; and/or a generalized analysis of the moral dilemma subject matter as the latter may be provided by, for example, Wikipedia.

The Dilemmas function satisfies a number of different objectives beyond the informative and entertainment objectives. Among these are the many educational opportunities both in a home and in a classroom. The Dilemmas function is advantageously designed to stimulate discussions among viewers regarding the moral dilemmas depicted within a movie. It provides an opportunity to compare and contrast the decisions viewers would make under similar circumstances, and to stimulate intellectual discussions that reveal an individual's character and values. The features of the Dilemmas function can serve to stimulate family conversations that could lead to a child's moral development and character growth. Within a classroom, teachers may use features of the Dilemmas function to showcase ethical practices and moral principles relevant to their subject matter. The Dilemmas function's second screen embodiment, responsive to a user's preferences, is configured to facilitate any of a number of educational, informative, and/or entertaining activities. For example, in one second screen embodiment, one individual (e.g., a parent/teacher) has access to a relationship descriptor and the moral principle descriptors and is able to query others (e.g., children/students) to identify them.

A user's answers to a moral dilemma questions may be tabulated and summarized at the end of the movie to inform the user of how the user's decisions compare to the agent's actions in the movie (e.g., what the characters decided), and/or compared to other users' answers to the moral dilemma questions. An entertaining psychological profile mat by provided the user that is responsive to the user's and community replies. Additionally, responsive to the user's preferences, dilemma answers may be posted to social media, and otherwise shared with friends (e.g., emailed), and the dilemma community at large. Aggregation of the data may provide a reading on the moral compass of a culture, and other opportunities for research.

FIG. 5C is an exemplary illustration of an implementation of the application interface simultaneously playing a movie and displaying information and features of a function. In a preferred embodiment, capabilities of a device, such as a Surface Pro, iPad Pro, laptop computer, or smart television, are utilized to simultaneously play a movie on a portion or window of the device, while providing the user the capability to access the various functions and features of the application. In one exemplary embodiment, the movie playing is performed by an independent application, while the Sync, Lists, and Games functions are provided by a second separate application. Alternatively, a single synergistically integrated application provides both movie playing with associated movie playing controls, and the Sync, Lists, and Games functions.

The particular synchronization methodology that is implemented is responsive to the level of integration between the movie playback functions and Sync, Lists, and Games functions, as well as the capabilities of the host system. In those instances that the movie playback application is independent of the application providing the Sync, Lists, and Games functions, whether the embodiment is a single system or a combination of primary/secondary systems, synchronization may implement a methodology similar to or analogous to those detailed in the '006 publication or the '630 publication. In a single device embodiment, the synchronizing function would take advantage of the speakers and microphones commonly available in these devices. In those instances that the movie playback application may provide information to the application providing the Sync, Lists, and Games functions, whether the embodiment is a single system/device or a combination of primary/secondary system/devices, synchronization may implement a passing/retrieving, whether cooperatively or not, of synchronizing information from one application to the other. In those instances that a synergistically integrated application provides both movie playing with associated movie playing controls, and the Sync, Lists, and Games functions, then the functions of the application internally share the necessary synchronization information.

In the exemplary illustration of FIG. 5C, the capabilities of a portable computing system 571, such as a Surface Pro, iPad Pro, laptop computer, are utilized to play a movie on a portion of the screen 572. Play controls 573 (e.g., pause/play) may be provided, as illustrated, by the single integrated application or by the separate movie playing application. In a preferred embodiment, double tapping the play/pause icon 573 enables a display of a complement of movie playback controls comprising, for example, play, pause, rewind, slow rewind, slow forward, fast forward, skip forward, skip backward, angle selection, what? (rewind with subtitles), audio/subtitle controls, and brightness controls. Additionally, an edit controls icon 574 enables a display of a complement of movie editing controls comprising, for example, mark in/out, clear, include/exclude, frame forward, frame backward, and time line information and controls. Full featured edit controls 574 facilitate creating customized presentations of the movie, playlist of segments from within the movie, and extracting one or a plurality of segments from within the movie.

The exemplary illustration of FIG. 5C depicts a Sync mode embodiment comprising a pull down menu icon button 581 that provides access to the functions of the application, on-demand functions icon buttons 582 to enable the Music, Quotes, Vehicles, Weapons, and Who on-demand functions, a timeline organized display of multiple function notifications 583, and features of the Dilemma function 591-595. In the exemplary embodiment illustrated in FIG. 5C, while the movie is playing or is paused in the movie playing window 572, responsive to the current movie play position, the movie map, and user actions, features 591-595 of the Dilemma function are displayed and enabled. In a preferred Sync mode embodiment, a notification of, and a displaying of, a moral dilemma question is in synchronization with a playing of a movie from which the moral dilemma is derived. Usually the location in the movie where the moral dilemma question is presented immediately follows the scene, portion of a scene, or depiction disclosing or establishing the elements of the moral dilemma, but ideally precedes the depiction disclosing the moral dilemma decision of the character.

The Dilemma function features are displayed and enabled comprise, for example, a function icon (e.g., Dilemma icon) 591 that identifies the active function (e.g., Dilemma function), a title 592 for a moral dilemma depicted within the movie (e.g., “Cloaks And Grog”), a moral dilemma question identifying the two moral principles that are in conflict 593 (e.g., “Would you have handed out warm clothing and grog to the needy residents of the castle (Responsibility To Citizenry) or would you have avoided giving away all of Arendelles' tradable goods (Financial Responsibility)?”), and a two moral principle labeled buttons 594 (e.g., “Responsibility To Citizenry” and “Financial Responsibility”) for a user to select a choice; and a video/snapshot 595 that is responsive to the function and current play position to provide visual context. In the event that the video/snapshot is a video rather than a single video frame, a single video frame (e.g., a video frame from within the video) may be displayed until the playing of the movie is paused.

This particular exemplary embodiment incorporates an innovative feature that addresses the shortcomings associated with written information. Advantageously, a user activating the read icon button 586 causes the playing of an audio that reads the dilemma question 593 for the user through, for example, the devices speakers. This feature may be implemented with any of the various function's write-ups or information items in any of the devises, and advantageously may be enabled by a user verbally requesting a reading (e.g., voice recognition of a “Read” command).

Given the number of notification function that may be activated, it is likely that insufficient time to view or interact with an information item (i.e., information display collisions) will occur between a display of a feature or an information item from one function and a display of a feature or an information item from a second function. A lock feature prevents a next information item from displaying prior to a user completing the use of a current information item. The lock feature may be automatically enabled by a timer providing a user pre-established or system default amount of time (e.g., 20 seconds), responsive to each function, that an information item is displayed. Alternatively, or additionally, a user interacting with a displayed information item or activating the lock icon button 587 enables the locking of the currently displayed information item (lock icon button is illustrated in the lock position). Deactivating the lock icon button 587 enables the display of a feature or information item currently in synchronization with the playing of the movie. In the exemplary illustration, a last displayed notification item 585 in the timeline display of multiple notifications 583 identifies the Recipe Function as being the function currently in synchronization with the playing of the movie. Deactivating the lock icon button 587 would cause the display of features and information items associated with the Recipe Function.

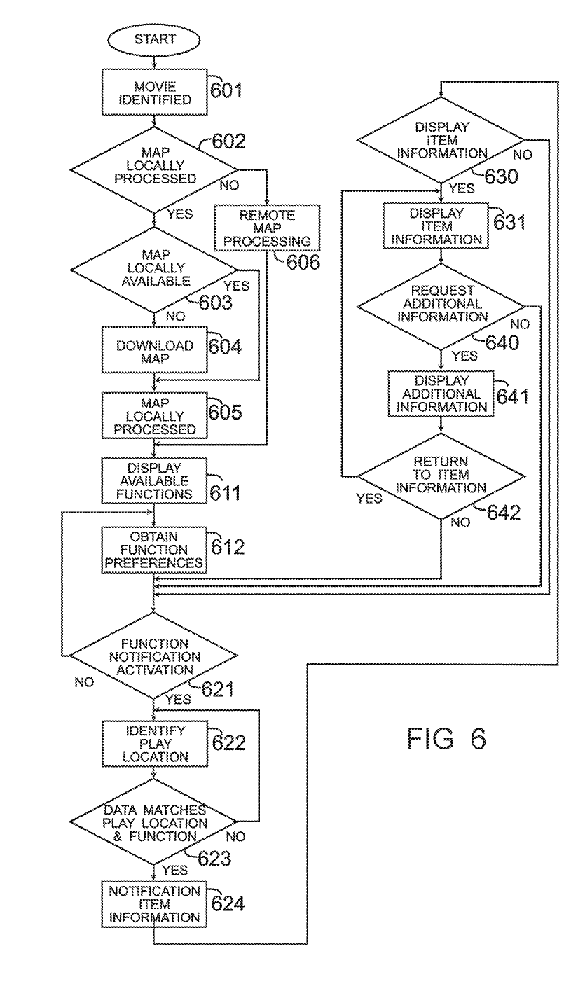

FIG. 6 is a flow chart of a method of accessing the dilemma function with an apparatus, such as a smartphone, tablet, personal computer, capable of processing information and instructions executable by a processor. This particular embodiment is detailed with respect to the Sync mode, and thus the Dilemma function is engaged substantially in synchronization with the playing of the corresponding movie. The disclosures of the '325 publication with respect to the Second Screen Embodiments (e.g., ¶¶ 219-265 and related FIGS) are incorporated herein by reference.

Referring to FIG. 6, in a preferred embodiment, following a selection of a movie, a user identifies the movie being played to the software application. Alternatively, the movie being played is identified by, for example, an audio fingerprint matching methodology. In an exemplary embodiment, as the movie is played, the application obtains sufficient instances of a representation (e.g., acoustic fingerprint, digital fingerprint, or audio signature) of the audio to be able to identify, within a certain time, the movie being played 601. If the movie or a particular release of the movie is not identified, an appropriate message seeking user input may be provided.

In those embodiments, where the movie map is processed locally by the system's application 602, once the movie is identified 601, a search of the available movie maps is performed 603 to determine if a movie map for the identified movie is currently stored in the system. If a map is not locally available 603, or if updating of maps is automatically performed at this point, then the map is downloaded from a remote source 604 (e.g., a web server) and processed 605 (e.g., merged with local user database and/or updating). If a map is locally available 603 and updating of the map is not required or possible, the map is locally processed 605 to display the available application modes and functions 611. If a map is not locally processed 602, then the map is processed by another system and/or remotely processed 606 in order to communicate to, and display the available modes and functions on, the local device 611.

A user's mode, function, and feature preferences may be pre-established, established, and/or modified at any time (e.g., prior to or during a playing of the movie). The mode, function, and feature preferences are obtained 612 to determine if notification functions are to be activated 621. If notification functions are not activated 621, then the application may return to the function preferences screen 612, ignore the notification routines and await on-demand function activation, and/or, for example, remain on standby mode to receive further user or system actions.

If notification functions are activated 621, then the current play location within a movie 622 is identified. In a second system embodiment (e.g., a smartphone), in a methodology similar to the identification of a movie 601, a current play position may be identified 622 by continuously and/or intermittingly matching audio samples (e.g., an acoustic signature) to a database of acoustic data to retain movie map synchronization with a playing of a movie on a primary system device (e.g., a television).

Once a play location is identified, the item data is queried (e.g., a plurality of video frame identifiers and/or segments are searched) to identify video frame identifiers and/or segments that are responsive to the play location and the particular notifications that are activated 623. If no data is responsive, then the play location is continued to be monitored 622. If data is responsive 623, a notification that item information is available is initiated 624 and/or the display of item information is activated 631. In addition to a visual display, the notification that item information is availability 624 may additionally or alternatively comprise and audio notification, vibration, and/or increase brightness of the second screen or portion of the second screen.

If the particular embodiment implements a contemporaneous display of features of a function 630, then alternatively to, or in addition to, the item notification 624, the information associated with an item that is responsive to the play location and the activated function (e.g., Dilemma function) 622 is automatically displayed 631. Item information comprises features of a function such as a dilemma question. If the particular embodiments does not implements an automatic display of features of a function 630, then, in addition to, the item notification 624 and following a user request, the features associated with an item that is responsive to the play location and the activated function 622 are displayed 631 (e.g., a dilemma question is displayed). If a user's request for item information is in response to a prior item notification, then the information associated with that prior notification is utilized to display the appropriate item information.

If a request is not received from a user for item information 630 in response to the display of an indication that item information is available 624, then, if the function notification mode is still activated 621, the current play position is continued to be monitored 622.

If a user requests additional item information 640 relating to displayed item information 631, then the display of additional item information is enabled 641 in response to the request for additional item information. Termination of the display of additional item information 642 returns to the screen providing item information 631. This would be particularly advantageous where multiple item information is displayed. Alternatively, termination of the display of additional item information 641 restores the function notification activation routines 621. A termination of the display of additional item information may take many forms, such as exiting the additional information function (e.g. exiting a website, and exit or escape request). If a user does not request additional item information relating to displayed item information 640, then the function notification activation routines 621 are restored, unless the user elects to exit the application.

The flow chart of FIG. 6 has been intentionally drafted to disclose a number of possible embodiments. A number of permutations, combinations, substitutions, and/or additions in the specific steps, and recursive functions may be initiated at different points in the process than those illustrated. In an exemplary embodiment, the function notification step 621 is responsive to a user activating an on-demand function (e.g., Who, What, Locations, Plot Info, Filmmaking, Trivia, and Info) during a playing of the movie. Such an action would then be followed by the identification of the current play position 622, the display of item information 631, and, if requested 640, the display of additional item information 641. Further, a step or steps may be performed at a local system (e.g., smartphone), by a remote system (e.g., remote server); or by a combination of systems (e.g., tablet, remote server, and third party website).

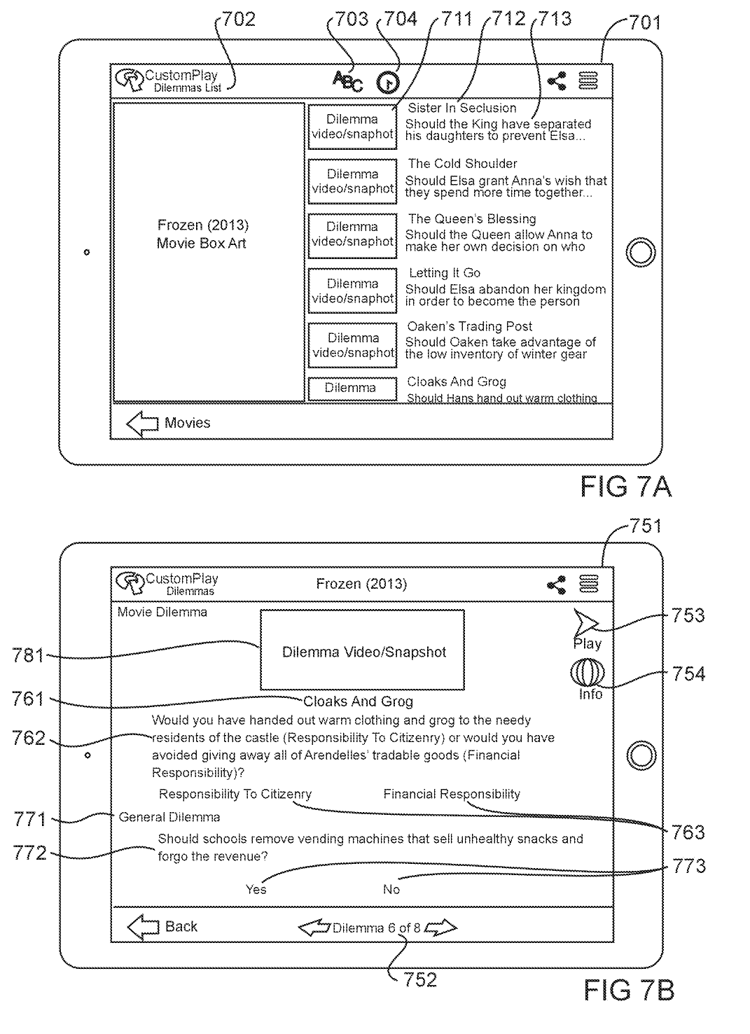

FIG. 7A is an illustration of an application interface displaying information and features of the Dilemma function in Lists mode. This interface screen 701 identifies Dilemmas List as the active function 702. In Lists mode the user may elect to order the list alphabetically 703 or by the timestamp 704 associated with the depiction of the dilemma within the movie. In this exemplary illustration, the list of dilemmas in the movie comprises a thumbnail video/snapshot 711 associated with the particular dilemma, the title of the dilemma 712, and, in this case, a portion of the question 713 or a write-up associated with the dilemma.

FIG. 7B is an illustration of an application interface displaying information and features of a dilemma question available in Lists mode. The features of the Dilemma function included in this exemplary embodiment 751 are similar to those included in Sync mode. The features of the Dilemma function depicted in FIG. 7B are similar to those previously depicted and comprise an identification that the moral dilemma question related to a depiction within the movie, a title 761 for a moral dilemma depicted within the movie, a moral dilemma question identifying the two moral principles that are in conflict 762, and an identification of the two moral principle options 763. Additionally, in this particular embodiment, contemporaneously included are the identification that an additional moral dilemma question relates to a general moral dilemma 771, the general dilemma question 772, and an identification of the yes/no options 773.

As is suggested by the illustrated left and right arrows and the identification of the current dilemma and the total number of dilemmas in the movie (e.g., Dilemma 6 of 8) 752, a user need not return to the List screen to access a preceding or following dilemma. An iPad embodiment, for example, enables swiping among the presentation of dilemma questions.

A principal aspect of the Lists mode is to provide efficient access to the items included in the function. To avoid potential conflicts with other modes, as is illustrated, a user's response need not be elicited, and thus the moral requirements possible answers 763 are not depicted in a button. In an alternate embodiment, and advantageously responsive to a user's preferences, the Dilemma function's features presented in List mode comprise some or all of the dilemma interactive features available in Sync mode (e.g., answer buttons and community data). In an embodiment that permits a user to answer the dilemma questions in Lists mode, the indications of the answer options 763 773 would be replaced with active buttons. In such an embodiment, for example, a selection of a moral requirement answer in response to a movie dilemma question would cause the display of the general dilemma question and selectable answer options. If a question has been previously answered in the Lists mode or in the other modes, the selected answers 763 773 may be highlighted and the user may be provided the opportunity to change the selection.

In this embodiment, in addition to, or alternatively to, the display of a background video/snapshot, a dilemma video/snapshot 781 is made available to provide context for the dilemma question 762. This is particularly advantageous since Lists mode will often be accessed independently of viewing the movie. In other words a user may access the dilemma questions without necessarily having previously viewed the movie. If the presented moral dilemmas are deemed compelling, a viewer may be encouraged to view a movie they may otherwise have not chosen to view. A video/snapshot may be any movie, set of movie segments, movie segment, video snapshot, video frame, image, or set of images that may provide information relating to a feature of a function. In the case of the Dilemma function, for example, the video/snapshot depicting Hans handing out clothing to the residents provides information (e.g., context) relating to the “Cloaks And Grog” dilemma. In another example, a video/snapshot would comprise a set of movie segments totaling 1-2 minutes extracted from within the movie that would provide a recap of, or context for, the moral requirements that are the central to the moral dilemma.

In a preferred second screen embodiment, a Dilemma replay feature 753 enables, for example, replaying on the primary screen the various previously played segments of the movie that precede the decision point and that assist the user in recollecting the relevant details and context of a Dilemma. Further, a linkage may be provided to external information or discussion on the topic 754.

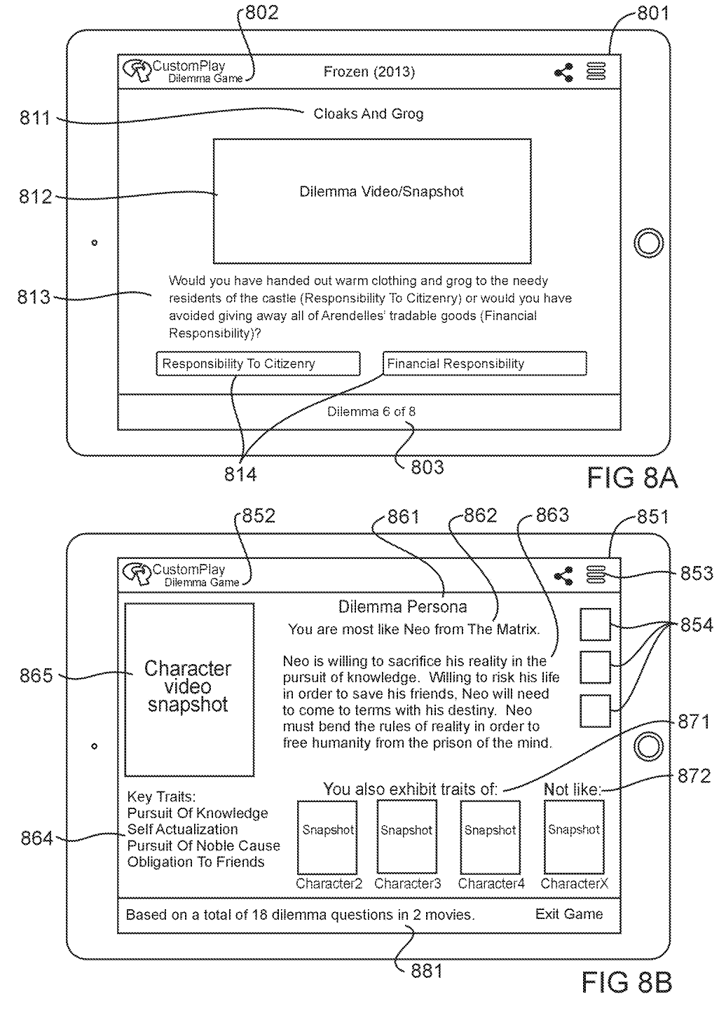

FIG. 8A is an illustration of an application interface displaying information and features of a dilemma available in Dilemma Game mode. This interface screen 801 identifies the Dilemma Game as the active function 802, and identifies the current dilemma and the total number of dilemmas in the game 803 (e.g., Dilemma 6 of 8). This exemplary embodiment 801 comprises the title of the dilemma 811, a dilemma video/snapshot 812, a dilemma question 813, and the potential dilemma answers 814. In a Dilemma Game, each dilemma question 813 is associated with a plurality of displayed answers 814. The displayed answers may take many forms, such as Yes/No, or, as illustrated, a plurality of standardized moral dilemma descriptors 814 (e.g., two moral dilemma descriptors).

The Dilemmas Game offers additional advantageous and novel features. In a preferred embodiment, a user's answers to the displayed moral dilemma questions are compared against information associating an answer to at least one moral dilemma question with at least one of a plurality of movie characters. Additionally or alternatively, a user's answers to the displayed moral dilemma questions are compared against information associating at least one answer to a moral dilemma question with at least one of a plurality of movie characters. The object of the comparing is to identify a movie character that is best matched to the user's answer selections. Such a matched character would exhibit distinguishing moral dilemma traits that are most aligned with a user's answers to the displayed moral dilemma questions. A separate object of the comparing is to also identify a movie character that is negatively matched to the user's answer selections.

The plurality of movie characters may be limited to those characters depicted in the corresponding movie. Alternatively and advantageously, the plurality of movie characters is created from the most noteworthy characters depicted in a plurality of movies. The set of movie characters may be updated with new noteworthy characters as new movies are released.

In a preferred methodology among a number of different comparing methodologies, a movie's noteworthy characters are analyzed to determine the extent to which a particular moral principle would guide the character's decision making or behavior. Based on the analysis, information is created that associates at least one appropriate moral principle descriptor with each of a plurality of movie characters from a broad selection of movies. Preferably each character is assigned a most appropriate set of moral principle descriptor, and each assigned moral principle descriptor comprises a comparative value. The comparative value (e.g., also relative value or weight) that is associated with a character's particular moral principle descriptor may be positive or negative. This methodology, which is independent of a how a character would respond to a particular moral dilemma (i.e., a conflict between two competing moral principles) is more efficient and advantageous than analyzing how a character would respond to a particular moral dilemma, or a methodology that attempts to address the potential permutation of the standardized set of moral principle descriptors. In other words an elegant simple methodology is focused on a character's distinguishing moral traits rather than an alternate possible embodiment that is dependent on a more complex analysis of a character's detailed moral framework.

In one preferred methodology, a noteworthy character from a movie is analyzed as to which moral principles guided or are likely to guide the character's decisions. A noteworthy character's defining and particular moral principles are generally those that tend to render the character memorable and idiosyncratic. In such a methodology, a character is associated with a subset of moral principle descriptors selected from a plurality of moral dilemma descriptors. For example, the character Neo in the movie The Matrix is positively associated with the following moral principle descriptors (the optional use of comparative or relative strength or weakness values are shown in [ ]): Pursuit Of Knowledge [+4], Self Actualization [+3], Pursuit Of Noble Cause [+2], and Obligation To Friends [+1], and negatively associated with the moral principle descriptor Respect For Rules And Laws [−4]. By contrast the character Agent Smith in the movie The Matrix is positively associated with the following moral principle descriptors: Self Actualization [+4], Self Preservation [+3], Self Respect [+2], and Personal Conviction [+1], and negatively associated with the moral principle descriptor Respect For Natural Order [−4].

In a responsive architecture, a user that when presented with moral dilemma questions selects Pursuit of Knowledge rather than Personal Welfare, Self Actualization rather than Honor Parent, Respect For Natural Order rather than Save Lives, and Self Respect rather than Obligation To Others, would receive and association value of +7 with respect to Neo (Pursuit Of Knowledge [+4] and Self Actualization [+3]) and an association value of +2 with Respect to Agent Smith (Self Actualization [+4], Self Respect [+2], and Respect For Natural Order [−4]). In this example, the user's responses would be best associated with the traits of the character Neo from The Matrix movie.

In a more developed embodiment, each character is associated with each of a complete set of moral dilemma descriptors, e.g., 76 unique moral dilemma descriptors. Such an embodiment necessarily comprises the use of a distinguishing methodology such as the use of comparative values. In a still more developed embodiment, a character is associated with a specific selection among two competing moral principle descriptors. For example, in the movie The Matrix, in a Follow The Rabbit scene, the character Neo chooses the moral principle Pursuit of Knowledge when confronted with the moral dilemma implicating the moral principle Obligation To Business and the moral principle Pursuit of Knowledge. In a Take A Pill scene, Neo chooses the moral principle Pursuit of Knowledge when confronted with a moral dilemma implicating the moral principle Pursuit of Knowledge and the moral principle Personal Welfare. In a Leap Of Faith scene, Neo chooses the moral principle Faithfulness when confronted with a moral dilemma implicating the moral principle Faithfulness and the moral principle Personal Welfare.

As in the other embodiments, the set of moral dilemmas may be a subset or a complete set of the actual moral dilemmas faced by the character in a movie or series of movies. Alternatively, the set may be a superset comprising an evaluation of how the character would deal with encountered and un-encountered moral dilemmas, e.g., a subset or the complete set of the potential combinations bringing into conflict the 76 unique moral dilemma descriptors (maximum superset of 2926 combinations). Such embodiments may be further developed by the use of relative strength or weakness values. Elements from the various disclosed embodiments may be selectively excluded or combined to create a moral dilemma profile for each of a plurality of movie characters that fits a particular implementation.

The '325 publication recited that: “To facilitate search across a plurality of movies, the relationship descriptors and the moral principle descriptors are advantageously standardized as descriptors of a few words.” (325 publication ¶315.) An unexpected and non-obvious material advantage of associating standardized moral principle descriptors with a character is that it facilitates an efficient comparing methodology to a user's responses to the moral dilemma questions. The use of standardized moral principle descriptors eliminates the need to reanalyze each character following the introduction of a set of moral dilemmas with a newly released movie. In other words, while a still more developed embodiment may address the details of each depicted moral dilemma, an elegantly simpler and effective comparing methodology does not need to address the particularly depicted subtle nuances of a movie's moral dilemma.

The use of standardized moral principle descriptors synergistically combined with a methodology that takes into consideration a user's responses across a plurality of movies offers the advantages of enabling the comparing to be responsive to a user's cumulative responses across a larger and broader set of moral dilemma questions. This would provide a far more accurate matching of a user's moral dilemma answers with the moral dilemma descriptors or moral dilemma profile associated with a movie character. The potential to compare responses to standardized moral dilemma descriptors facilitates a more developed and corroborated analysis of a user's moral principles.

FIG. 8B is an illustration of an application interface displaying information and features of a Dilemma Game. This interface screen 851 identifies the Dilemma Game as the active function 852 and is presented at the conclusion of the dilemma game or on-demand via the pull down menu icon button 853 which provides access to the functions of the application including the awards screen (e.g., this interface screen 851). Dedicated social media buttons (e.g., Facebook, Twitter, and Email) 854 provide efficient posting and communications capabilities that are responsive to pre-established information relating to the active function. For example, activation of the Facebook icon would enable the applications automated preparation of a posting of information, images, and links consistent with Facebook's requirements and responsive to the dilemma game persona screen.

This interface screen is identified to the user as the Dilemma Persona screen 861 which provides the user with an identification of the character 862 that best reflects the moral principles associated with the user's responses (e.g., “You are most like Neo from The Matrix.”). The interface screen also provides a write-up describing the character's defining moral qualities 863 (e.g., “Neo is willing to sacrifice his reality in the pursuit of knowledge. Willing to risk his life in order to save his friends, Neo will need to come to terms with his destiny. Neo must bend the rules of reality in order to free humanity from the prison of the mind.”); the list of the character's key traits or guiding moral principles 864 (e.g., Pursuit Of Knowledge, Self Actualization, Pursuit Of Noble Cause, and Obligation To Friends); and the character's video/snapshot 865 preferably extracted from within the movie in which the character's qualities were best depicted. Preferably the write includes flavor and/or memorable quotes from the movie.

Advantageously, in a preferred embodiment, the interface screen also identifies at least one other character whose moral qualities are consistent with the traits exhibited by the user's responses 871. In the illustration, the user also exhibits traits of Character2, Character3, and Character4. Advantageously, in a preferred embodiment, the interface screen 851 also further identifies at least one character whose moral qualities are inconsistent with the traits exhibited by the user's responses 872. In the illustration, the user exhibited traits that are not like those of CharacterX. The identification of a character 871 872 may include a character's name and/or snapshot. An alternate embodiment may maximize the entertainment value by temporarily withholding the name of a character otherwise identified by a snapshot. Consistent with a methodology that takes into consideration a user's responses across a plurality of movies, the interface screen provides the total number of dilemma questions answered and the number of movies 881 (e.g., “Based on a total of 18 dilemma questions in 2 movies.”)

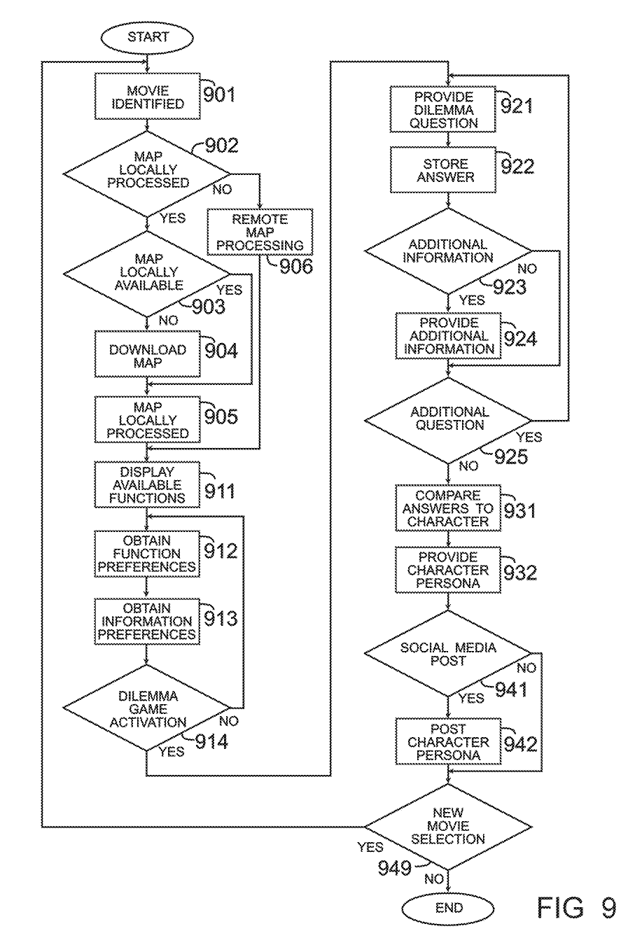

FIG. 9 is a flow chart of a method of playing a dilemma game on a system, such as a smartphone, tablet, personal computer, comprising conventional processing, memory, and communications capabilities. This particular embodiment is detailed with respect to the Game mode of the application, and thus the dilemma game is played without requiring a contemporaneous playing of the movie. However, the game detailed herein may be played substantially in synchronization with the playing of the corresponding movie as detailed above with respect to the Dilemma Sync mode. In other words the dilemma question is presented to the user at a location in the movie where the depiction of a moral dilemma question becomes apparent.

Referring to FIG. 9, typically, a user identifies a movie that the user is interested in playing the dilemma game. Alternatively, if a movie is being played or was recently played, the movie is identified by, for example, an audio fingerprint matching methodology. In those embodiments, where the movie map is processed locally by the system's application 902, once the movie is identified 901, a search of the available movie maps is performed 903 to determine if a movie map for the identified movie is currently stored in the device. If a map is not locally available 903, or if updating of maps is automatically performed at this point, then the map is downloaded from a remote source 904 and processed 905 (e.g., merged with local database). If a map is locally available 903 and updating of the map is not required or possible, the map is locally processed 905 to display the available application modes and functions 911. If a map is not locally processed 902, then the map is processed by another system or remotely processed 906 in order to communicate to, and display the available modes and functions on, the local system 911. Remote processing of the map is analogous to a website implementation methodology that serves pages or information to a device.

The mode, function, and feature preferences are obtained 912 and the information preferences 913 are also obtained to determine if the Dilemma game is to be activated 914. The Dilemma game may be activated in either Sync mode or Game mode. In a preferred embodiment, the Dilemma game is responsive to a user's information preference. In those instances, at least one question and answers set is associated with a specific audience (e.g., adults, families, teens, children, couples). While the utilization of information preferences is generally advantageous with a number of the application's function, it is particularly advantageous with the Dilemma function. In a preferred embodiment, responsive to the nature of the dilemma subject matter, one complete set of dilemma questions and answers is specifically drafted for, and is suitable for, a younger audience, while an alternate and not necessarily parallel set is specifically drafted for, and is suitable for, a mature audience. In those embodiments, the movie map would include the appropriate identification and association of the information supporting the function's potential information preferences.

If the Dilemma game is not to be activated 914, then the application may return to the function preferences screen 912, and/or, for example, remain on standby mode to receive further user or system actions. If the Dilemma game is to be activated 914, then the application would provide, responsive to a system default or a user's information preferences, a dilemma question 921 from the set of dilemma questions available for the selected movie. A user's answer to the dilemma question is then stored 922 for subsequent processing. In those instances that the Dilemma game implemented features comprise additional information 923, then, responsive to a user's request for additional information, the additional information is provided 924. The additional information includes, for example, a general dilemma question, a play dilemma feature that enables playing the various segments of the movie relating to the moral dilemma, and an info dilemma feature that provides access to internal or external additional information relating to the implicated moral principles and the depicted moral dilemma. Herein, providing includes transmitting, displaying, verbalizing, visualizing and/or otherwise presenting to a user.

Depending on the embodiment, immediately following a user response to a question or a user exiting the additional information features, a next question, if available 925, from the set of dilemma questions is provided to the user 921. A user's answer to the dilemma question is then stored 922 for subsequent processing. Once all the questions from the set of dilemma questions have been provided, the stored user answers are compared to the set of character moral dilemma profiles 931 to identify and provide to the user the character most matched to the user's answers 932. The step of identifying a movie character whose moral dilemma traits are most responsive to a user's answers to the moral dilemma questions 932 may also comprise identifying those additional movie characters that also exhibit traits that are responsive to the user's answers, and identifying a movie character whose moral dilemma traits are least responsive to the user's answers.

Advantageously, a user is provided the automated social media posting and communicating capabilities 941 to post or communicate an identified character persona to one or a plurality of social media platforms (e.g., Facebook) and communication channels (e.g., email). The process is concluded with the exiting of the gaming routines for the game. Optionally, a user is provided the means to replay the game and adjust their responses. Advantageously, following the completion of the Dilemma game mode, the List mode also provides the means to review each of the dilemma questions and the answers that the user selected. Alternatively, the List mode may also provide a more casual means to play the Dilemma game.

The flow chart of FIG. 9 has been intentionally drafted to disclose a number of possible embodiments. A number of permutations, combinations, substitutions, and/or additions in the specific steps, and recursive functions may be initiated at different points in the process than those illustrated. Further, a step or steps may be performed at a local system (e.g., smartphone), by a remote system (e.g., remote server); or by a combination of systems (e.g., tablet, remote server, and third party website). For example the step of comparing a user's answers to a character's profile 931 may be performed locally or remotely (e.g., a remote web server that processes an API request from a user's smartphone).

In an alternate simpler embodiment of the Dilemma game, the application is a single function application focusing on the dilemma game. In such an embodiment, the movie map would principally comprise or only include the information necessary to play the game. Thus, the steps of displaying the available modes and functions 911, obtaining the mode, function, and feature preferences 912, and determining if the dilemma game is to be activated 914 would be replaced by the automatic step of activating the dilemma game. Even in this embodiment, the Dilemma game may be played contemporaneously with a playing of the corresponding movie in a manner similar to that disclosed with respect to Sync mode.

Advantageously, the Dilemma game is intended to be cumulative, i.e., a user's answers to the moral dilemma questions presented in a Dilemma game of one movie are combined with the user's answers to the moral dilemma questions presented in a Dilemma game of a subsequent movie. Combining a user's answer selections with previously received sets of user's answer selections will over time enhance the matching of a user's cumulative answers to the moral dilemma traits of movie characters. The real-time matching of user answers to character traits enables the addition of new characters from recent movie releases that exhibit noteworthy or idiosyncratic moral dilemma profiles. The cumulative nature of the game and the addition of new characters promote playing of the Dilemma game of additional movies (represented in the flow chart of FIG. 9 as step 949). In that context, with the introduction of a new character a user may be notified of a new character persona (e.g., based on a recent movie release your moral dilemma profile now most closely matches the Max Rockatansky character from the movie Mad Max Fury Road). The notification may occur independently of a contemporaneous use of the application, upon a new activation of the application, or, for example, an activation of the Dilemma game function. Thus, in a preferred embodiment, the steps of comparing the set of character moral dilemma profiles 931 and identifying a character that most matches a user's answers 932 take into consideration the most updated set of character profiles as well as a user's combined answers from multiple Dilemma games.

In a preferred embodiment, the various end user systems disclosed herein are capable of, independently or in combination, displaying a plurality of moral dilemma questions, each of which is associated with a plurality of displayed answers; receiving a user's answer selections in response to the displayed plurality of moral dilemma questions; comparing the user's answer selections against information associating at least one answer to a moral dilemma question with at least one of a plurality of movie characters; and identifying, responsive to the comparing, a movie character that is matched to the user's answer selections.

In another preferred embodiment, the various systems disclosed herein are capable of displaying a plurality of moral dilemma questions, each of which is associated with a plurality of moral principles; receiving a user's moral principle selections in response to the displayed plurality of moral dilemma questions; comparing the user's moral principle selections against information associating at least one moral principle with at least one of a plurality of movie characters; and identifying, responsive to the comparing, a movie character that is matched to the user's moral principle selections.

In still another preferred embodiment, the various systems disclosed herein are capable of displaying a plurality of moral dilemma questions, each of which is associated with a plurality of displayed answers; receiving a user's answer selections in response to the displayed plurality of moral dilemma questions; combining the received user's answer selections with a previously received sets of user's answer selections; comparing the combined user's answer selections against a moral dilemma profile of each of a plurality of movie characters; and identifying, responsive to the comparing, a movie character that is matched to the combined user's answer selections. In a preferred embodiment, the previously received set of user's answer selections was responsive to a set of moral dilemma questions derived from a movie that is different than the movie from which the displayed plurality of moral dilemma questions are derived

Optionally, additionally, or alternatively, in these and other embodiments disclosed herein, a displaying of the moral dilemma questions is in synchronization with a playing of a movie from which the moral dilemma questions are derived; a plurality of displayed answers comprises a plurality of moral dilemma descriptors, an identifying further comprises identifying a movie character that is negatively matched to the user's answer selections; the information associating at least one answer to a moral dilemma question with at least one of a plurality of movie characters comprises a comparative value; the information associating at least one moral principle with at least one of a plurality of movie characters, associates a moral dilemma descriptor and a comparative value; the movie characters are selected for their distinguishing positive and/or negative moral traits; the plurality of moral principles are responsive to a set of standardized moral principle descriptors; and/or at least one moral principle associated with a character is at least one of the standardized moral principle descriptors.

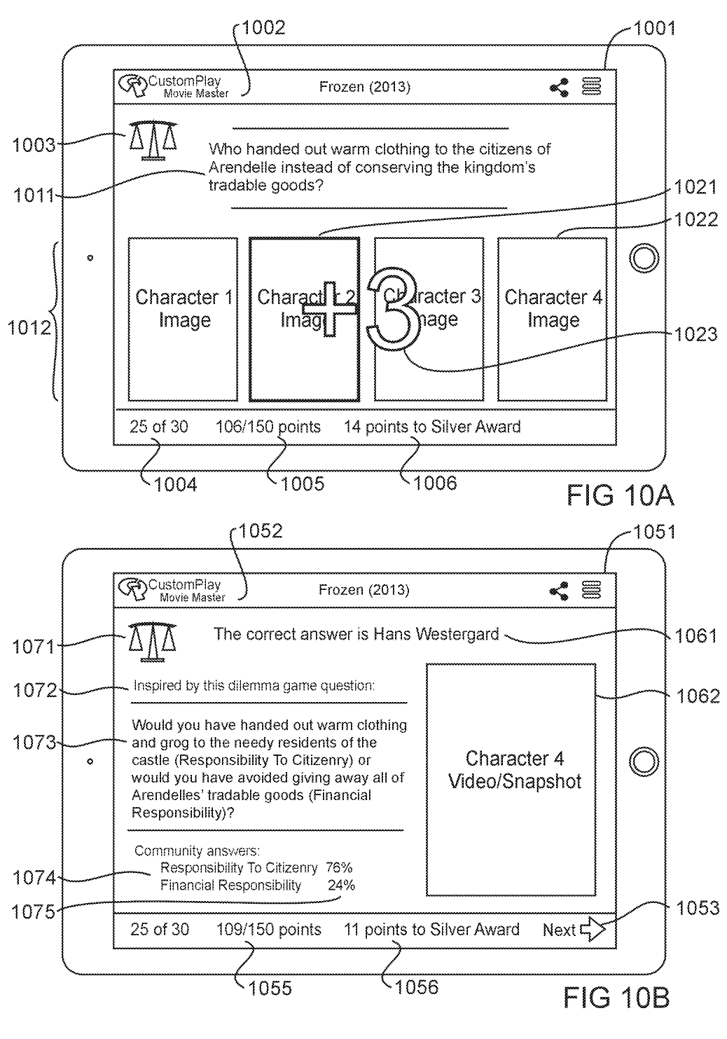

FIG. 10A is an illustration of an application interface displaying information and features of a dilemma question in the Movie Master game. This interface screen 1001 identifies the Movie Master game as the active function 1002. An object of the Movie Master game is to provide a set of questions that are immersed within the context of a single movie and that cover a broad range of entertaining and informative content categories. Additionally, a primary, advantageous, and innovative object of the Movie Master game is to introduce to the user the principal features of each of the application's informative and entertaining movie-related functions (e.g., Dilemmas, Filmmaking, Locations, Music, Plot Info, Quotes, Recipes, Shopping, SuperFans, Trivia, Vehicles, Weapons, and Who) within the context of a challenging game experience. Generally, a feature relates to the format or manner in which information of a function is presented or to a particular presentation or methodology associated with a function.

In the exemplary illustration, the function being introduced and that is the source of a question is identified 1003 (e.g., an icon associated with the Dilemma function). Associating the identification of the specific function 1003 with a question 1011 may motivate a user interested in that particular category of questions and information to additionally access the corresponding function in either Sync or Lists modes. In the exemplary interface screen 1001, the current question and total number of questions are identified 1004 (e.g., 25 of 30), and a running point total or score is displayed 1005 (e.g., 106/150 points) together with information relating to the number of additional points necessary to achieve an award level 1006 (e.g., 14 points to Silver Award).

The Movie Master game question need not be exactly the same as a source question or information item of the corresponding function. For example, in the Movie Master game, the dilemma question 1011 (“Who handed out warm clothing to the citizens of Arendelle instead of conserving the kingdom's tradable goods?”) is based on a rephrasing of a source dilemma question of the Dilemma function in Sync and Lists modes (e.g., “Would you have handed out warm clothing and grog to the needy residents of the castle (Responsibility To Citizenry) or would you have avoided giving away all of Arendelles' tradable goods (Financial Responsibility)?”). Similarly, for example, while in the source Dilemma function question, the user is asked to select among two competing moral principles, in the Movie Master Game, the user is asked to select among the images of four characters 1012 depicted within the movie.

Advantageously, the Movie Master game is standardized as one question and four optional answers irrespective of the feature from which the question is obtained. For example, in the Movie Master game, the dilemma question 1011 is associated with the depiction of the images of four characters 1012 from the corresponding movie. Standardizing the number of question facilitates implementing a multi-try methodology. In a preferred embodiment, a user is provided at least two opportunities (attempts, tries) to identify the correct answer to a question. The multi-try methodology also incorporates a point scoring system that is responsive to the multiple-fry scheme. For example, in a three try embodiment, an identification of a correct answer on a first attempt is associated with five points, an identification of a correct answer on a second attempt is associated with three points, an identification of a correct answer on a third attempt is associated with one point, and a default final answer receives no points. The number of tries that are provided need not be one less than the number of potential answers. For example, a user may be provided two tries to select a correct answer from a potential of four or five displayed answer options.

In the exemplary interface screen 1001, an incorrect first attempt is followed by an appropriate incorrect audio sound and the highlighting of the selected answer 1021 to both confirm the selection and to remind the user of a previous incorrect selection. A correct selection 1022 is followed by an appropriate correct audio sound and a brief display of the awarded points 1023 (e.g., +3). The Movie Master game, the Trivia game, and the Music game may each incorporate a variety of different scoring methodologies, and the scoring methodologies need not be same across the games or be same for a game from one movie to the next movie. For example, a game may incorporate a classic methodology in which one point is awarded for each correct answer on a first try only. Alternatively, a game may incorporate a timed-countdown methodology in which a clock counts down from 30 seconds beginning 10 seconds after the question is first displayed. Points are awarded based on how quickly the answer is provided, 30 points are awarded if the correct the answer is provided within the 1rst second, 29 points if within 2nd second . . . . At 30 seconds a question can no longer be answered and no points may be awarded. Still alternatively or additionally, even in the context of a multi-try methodology, a game scoring may reflect the relative difficulty level of each question.

In a preferred embodiment, consistent with the innovative object of the Movie Master game, the identification of a correct answer by either the user or by default is not immediately followed by a next question. Rather, the identification of a correct answer is followed by additional information highlighting the features of the function associated with the recent question. In a preferred embodiment, the interface screen 1001 FIG. 10A displaying information and features of a dilemma question in the Movie Master game is followed by an interface screen displaying information and features of the Dilemma function. FIG. 10B is an illustration of an application interface displaying information and features of the Dilemma function within the Movie Master game. As in other exemplary illustrations, the interface screen 1051 identifies the Movie Master game as the active function 1052. A next feature 1053 enables the user to advance to the next question, if available, or to the completion of the game (e.g., the award screen).

An immediate function of the interface screen 1051 following the completion of the question is to confirm the correct answer (e.g., the identification of the character's name 1061 and displaying the correct image of the character 1062). In the exemplary interface screen 1051, an updated running point total or score is displayed 1055 (e.g., 109/150 points) together with updated information relating to the number of additional points necessary to achieve an award level 1056 (e.g., 11 points to Silver award). In this example, the user has already obtained enough points for the Bronze award and is now on the way to attempting to collect the additional points required for the Silver Award.

Consistent with the innovative object of the Movie Master game, a principal function of the interface screen 1051 following the completion of the question is to identify the function, by, for example, a function icon 1071 (e.g., Dilemma function icon), and a function relationship 1072 to the preceding question (e.g., “Inspired by this dilemma game question:”), and to provide additional information of the related function. In this illustration, the additional information of the related function comprise the source dilemma question 1073, source selectable responses 1074, and statistics based on how the community responded to the source question 1075.

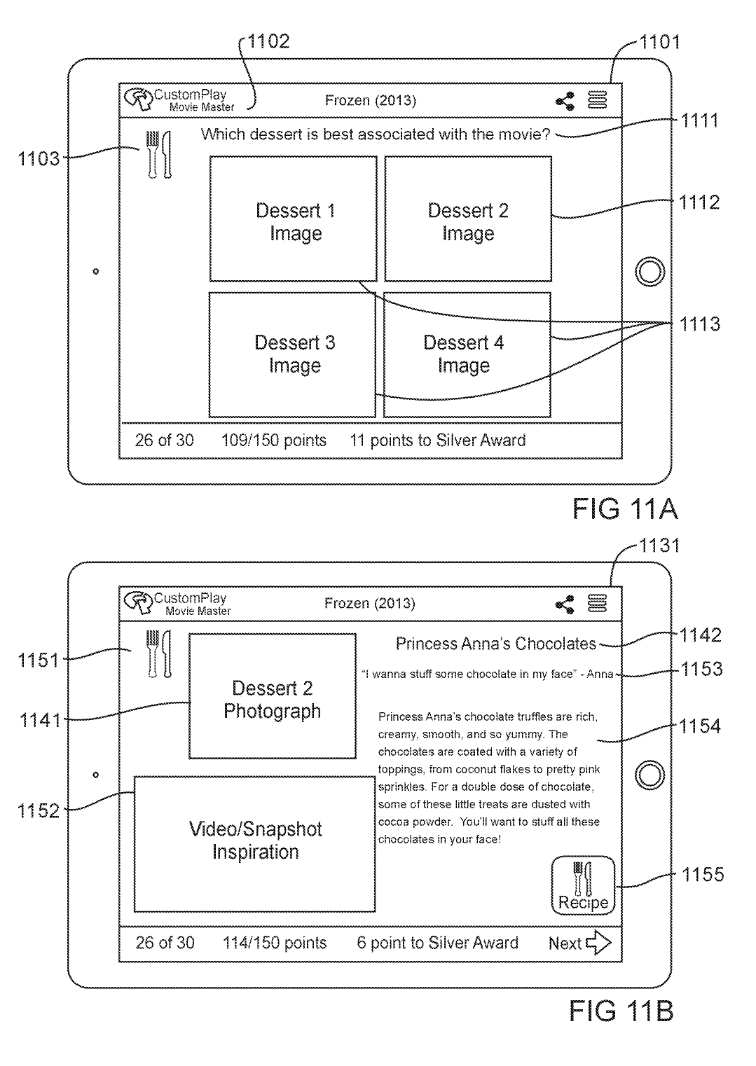

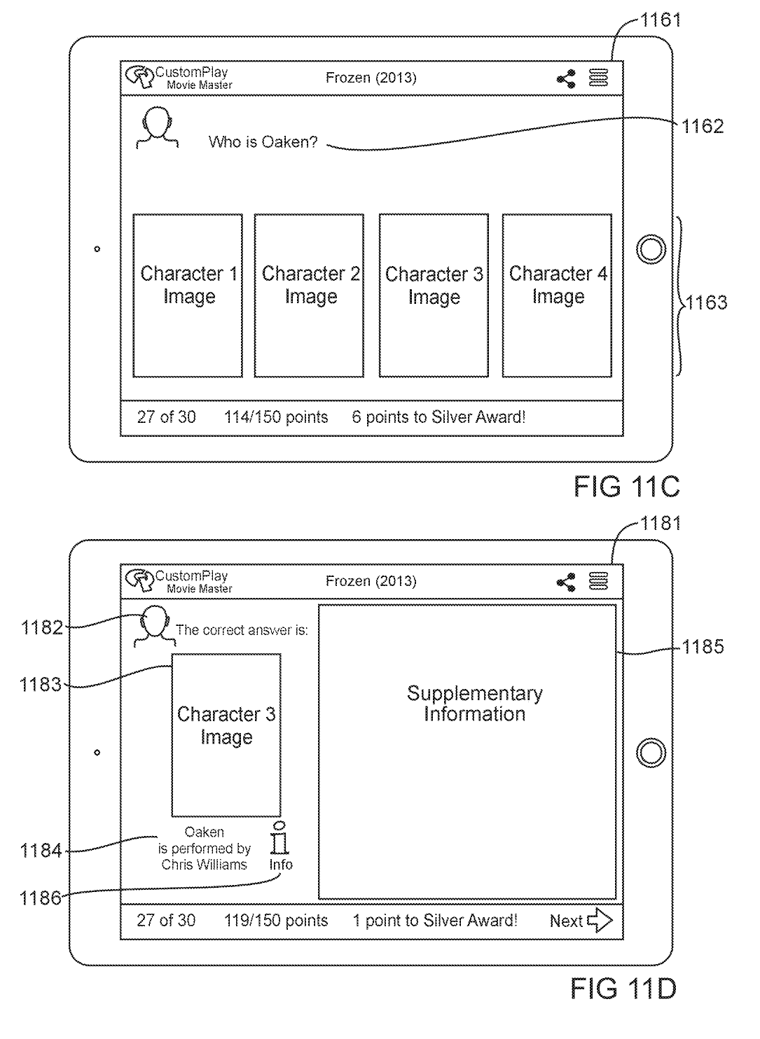

FIG. 11A is an illustration of an application interface displaying information and features of a recipe question in the Movie Master game. Recipe refers to depictions and/or information relating to a food item such a drink, appetizer, main, side, and dessert. This interface screen 1101 identifies the Movie Master game as the active function 1102, and identifies the function being introduced 1103 (e.g., an icon associated with the Recipe function) and that is the source of the question. In this exemplary embodiment of a recipe question, the Movie Master game question is not a rephrasing of a source question. Rather, the question (e.g., “Which dessert is best associated with the movie?”) 1111 is based on the presentation of a photograph of a dessert 1112 (e.g., Dessert 2) which has a strong creative relationship and/or is distinctly anchored to the target movie (i.e., the currently selected movie). The remaining selectable photographs of desserts 1113 (e.g., Dessert 1, 3, and 4) are distinguished from the correct answer 1112 by their own creative relationship to, in this example, their respective movies.

The information supporting the Recipe function may be further supplemented to support other embodiments that are consistent with the Movie Master game architecture. For example, the supplementary information may enable asking the user to select, from a plurality of snapshots selected from within the movie, a snapshot that is the best inspiration for a depicted food recipe. In this and other embodiments, the object is to create a relationship with, and interest in, the underlying function.

FIG. 11B is an illustration of an application interface displaying information and features of the Recipe function within the Movie Master game. As in other exemplary illustrations, the interface screen 1131 identifies the Movie Master game as the active function, confirms the correct answer 1141 (e.g., the correct food item photograph of the dessert is displayed), and provides additional information related to the correct answer (e.g., the identification of the food item “Princess Anna's Chocolates”).

Advantageously, in a preferred embodiment, the related Recipe function is identified 1151 (e.g., Recipe function icon), and additional information introducing features of the Recipe function are provided. The additional information includes, for example, a movie video/snapshot 1152 that depicts the inspiration for the food item; a quote 1153 (e.g., “I wanna stuff some chocolate in my face”—Anna) from the movie that provides inspiration for, or is creatively related to the depicted food item; a food recipe write-up 1154 (e.g., “Princess Anna's chocolate truffles are rich, creamy, smooth, and so yummy. The chocolates are coated with a variety of toppings, from coconut flakes to pretty pink sprinkles. For a double dose of chocolate, some of these little treats are dusted with cocoa powder. You'll want to stuff all these chocolates in your face!”) relating to the identified food item; and a recipe icon 1155 that provides access to the actual recipe for the targeted food item (e.g., preparation time, servings, list of ingredients, preparation instructions, purchase links to special items or tools, individual and community ratings, and social media features).

The information supporting the presentation of a recipe question within the Movie Master game is suitable to support a stand alone Recipe function game. To provide a variety in presentation of the question/answers sets and to increase the potential questions that may be available for a motion picture, additional question/answers formats may be implemented. For example, a recipe image is displayed and a user is asked to select a scene written description from a set of scene written descriptions that best inspires the recipe. Similarly, a recipe image is displayed and a user is asked to select a video frame from a set of the movie's video frames that best inspires the recipe.

Still further, a Recipe function game may implement an entirely different gaming format. For example, a user is asked to match each of a plurality of movie box arts with a corresponding recipe image from a plurality of recipe images. In one embodiment, an indication is provided to the user as each match is correctly identified by the user. A user may or may not be allowed multiple attempts at correctly associating a movie box art to a recipe image. Advantageously, in a more challenging embodiment of that game, the user would not be provided information as to correct matches unless all the matches were correctly identified by the user. Such an embodiment would provide for multiple attempts at associating a movie box art to a recipe image.

The application's modes and the information supporting a function's features has the potential to enable a great variety of informative and entertaining embodiments. For example, during Sync mode, rather than automatically displaying recipe information, a user would merely be notified that the current scene has inspired a recipe. In addition to an icon representing the function, a video frame within the movie and responsive to the function and current play position is also displayed to clearly identify the video frame that is the source of the recipe inspiration. In such an embodiment, the user would be given an opportunity to think of potential recipes prior to the inspired recipe being revealed. The recipe's ingredients may be sequentially time-spaced revealed to provide additional clue to the user. Alternatively, or additionally, a user may be provided a set of recipe titles from which to select the title associated with the recipe created for the scene. At any time during the process, a next key or reveal key advances the process or discloses the created recipe.

FIG. 11C is an illustration of an application interface displaying information and features of a character identification question in the Movie Master game. In this exemplary interface screen embodiment 1161 of a character identification question (Who function), the Movie Master game question 1162 is in a written format (e.g., “Who is Oaken?”. However, in an exemplary embodiment, the presentation of the answers implements a format often used with respect to the identification of a character. In such an answer format, the user is asked to select among the depictions of four character video/snapshots 1163 depicted within the movie. The interface screens providing supplementary information or displaying information and features of a function would be responsive to the question and answer format implemented. For example, in the case that the answers are images of characters, the supplementary information would provide appropriate introductory text and a correct character image.

FIG. 11D is an illustration of an application interface displaying information and features of the Who function within the Movie Master game. As in other exemplary illustrations, in this particular embodiment of the Who function, the interface screen 1181 identifies the Who function as the active function 1182, confirms the correct answer with a snapshot 1183 of the correct character (e.g., an image of Oaken), identifies the performer (e.g., Oaken is performed by Chris Williams) 1184, and provides supplementary information 1185. In this embodiment, responsive to a user preference and linkage information, the supplementary information 1185 provided defaults to, for example, a website page providing information about the performer (e.g., Chris Williams IMDb website page) who performed the character (e.g., Oaken in the movie Frozen) and comprises a performer image, biography information, and filmography information. Advantageously, an additional information icon button 1186 enables toggling the supplementary information 1185 between the performer information and character information. In the case of character supplementary information, the Who function information includes a write-up of the character and additionally or alternatively a linkage to a website page of the character (e.g., disney.wikia.com/wiki/Oaken). In a preferred embodiment, the information icon button 1186 enables a user to sequence through a plurality of informative and/or entertaining supplementary information related to the performer and/or the character. For example, in this implementation, the information supporting the Who function comprises a plurality of website links each specifically chosen for their particularly noteworthy entertainment or information value (e.g., mic.com/articles/79455/7-moments-that-made-frozen-the-most-progressive-disney-movie-ever).

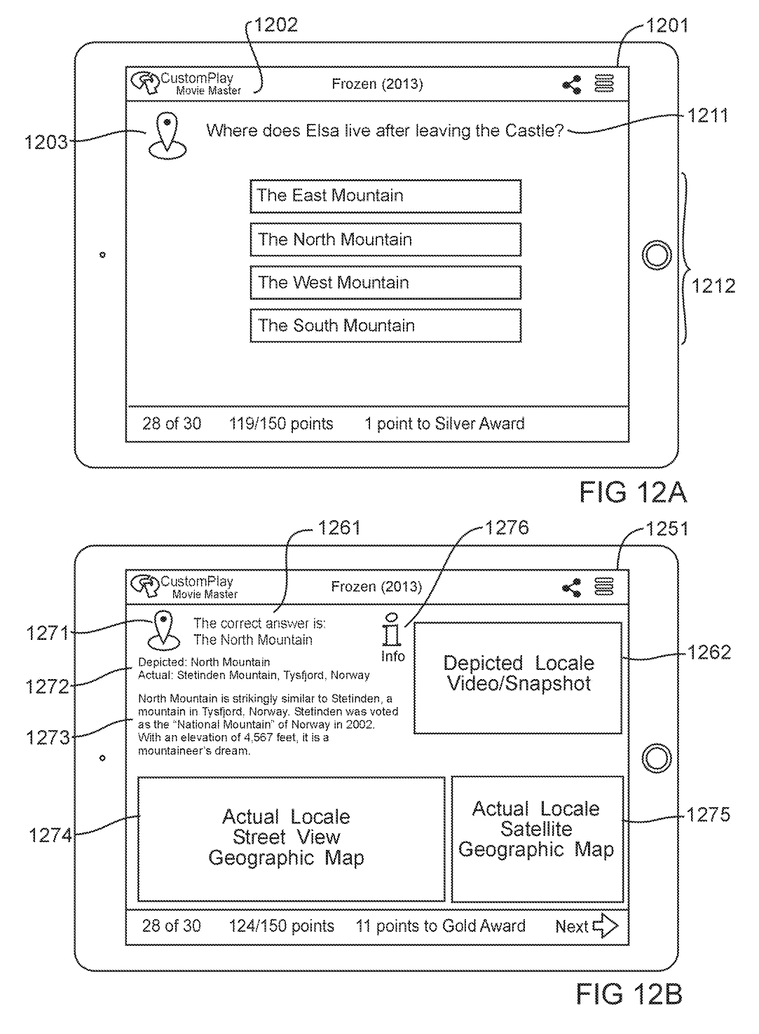

FIG. 12A is an illustration of an application interface displaying information and features of a location question in the Movie Master game. This interface screen 1201 identifies the Movie Master game as the active function 1202, and identifies the function being introduced 1203 (e.g., an icon associated with the Locations function) and that is the source of the question. In this exemplary embodiment of a location question, the Movie Master game question is also not a rephrasing of a source question. Rather, the question (e.g., “Where does Elsa live after leaving the Castle?”) 1211 is based on the identification of a locale represented or depicted within the movie and included among the four selectable answers 1212.

FIG. 12B is an illustration of an application interface displaying information and features of the Locations function within the Movie Master game. As in other exemplary illustrations, the interface screen 1251 identifies the Movie Master game as the active function, confirms the correct answer 1261 (e.g., “The correct answer is The North Mountain”), and provides a video/snapshot 1263 (e.g., a video frame) from within the movie and related to the depicted locale.

Advantageously, in a preferred embodiment, the related Locations function is identified 1271 (e.g., Locations function icon), and additional information introducing features of the Locations function are provided. The additional information includes, for example, an identity of the locale as represented in the movie and an actual identity of the locale 1272 (e.g., Depicted: North Mountain. Actual: Stetinden Mountain, Tysfjord, Norway”); a write-up 1273 (e.g., “North Mountain is strikingly similar to Stetinden, a mountain in Tysfjord, Norway. Stetinden was voted as the ‘National Mountain’ of Norway in 2002. With an elevation of 4,567 feet, it is a mountaineer's dream.”) related to the identified actual locale (e.g., “Stetinden Mountain, Tysfjord, Norway”); an interactive Street View geographic map of the actual locale 1274; an interactive satellite geographic map of the actual local 1275 being at substantially the same latitude and longitude as the Street View map but at a substantially different magnification; and an information icon 1276 to enable a user to retrieve, for example, corresponding website pages of additional information relating to the actual locale. For example, in the case of a locale being associated with a restaurant, the additional information relating to the actual locale would be a menu of the restaurant's meals.

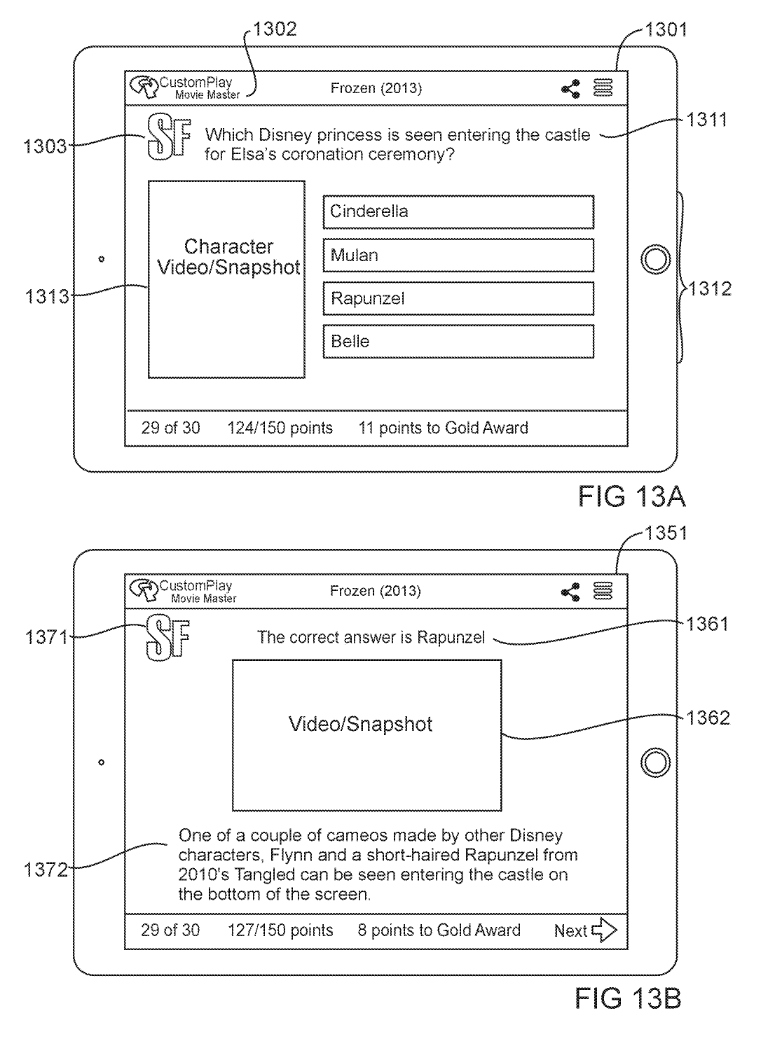

FIG. 13A is an illustration of an application interface displaying information and features of a superfan question in the Movie Master game. This interface screen 1301 identifies the Movie Master game as the active function 1302, and identifies the function being introduced 1303 (e.g., an icon associated with the SuperFan function) and that is the source of the question. In this exemplary embodiment of a superfan question, the Movie Master game question is usually a rephrasing of a source question. For example, in the Movie Master game, the superfan question 1311 (“Which Disney princess is seen entering the castle for Elsa's coronation ceremony?”) is based on a rephrasing of a source information item of the SuperFan function in Sync and Lists modes (e.g., “One of a couple of cameos made by other Disney characters, Flynn and a short-haired Rapunzel from 2010's Tangled can be seen entering the castle on the bottom of the screen.”). In this exemplary embodiment, the user is asked to select among four written answers 1312. In an alternate embodiment, the user may be asked to select among the images of four characters depicted in the respective movies. Optionally, a character video/snapshot 1313 may be included in those instances where the question identifies a character (e.g., “Elsa's coronation ceremony”)

FIG. 13B is an illustration of an application interface displaying information and features of the SuperFan function within the Movie Master game. As in other exemplary illustrations, the interface screen 1351 identifies the Movie Master game as the active function, confirms the correct answer 1361 (e.g., “The correct answer is Rapunzel”), and provides a video/snapshot 1362 (e.g., a video frame) from within the movie and related to the correct answer (e.g., a video frame depicting the Disney character Rapunzel in the bottom of the video frame).

Advantageously, in a preferred embodiment, the related SuperFan function is identified 1371 (e.g., SuperFan function icon), and additional information introducing features of the SuperFan function are provided. The additional information includes, for example, an information item write-up 1372 (e.g., “One of a couple of cameos made by other Disney characters, Flynn and a short-haired Rapunzel from 2010's Tangled can be seen entering the castle on the bottom of the screen.”) Although it need not be the case, in this example, the write-up 1372 is the same SuperFan function write-up that is provided in the Sync and Lists modes.

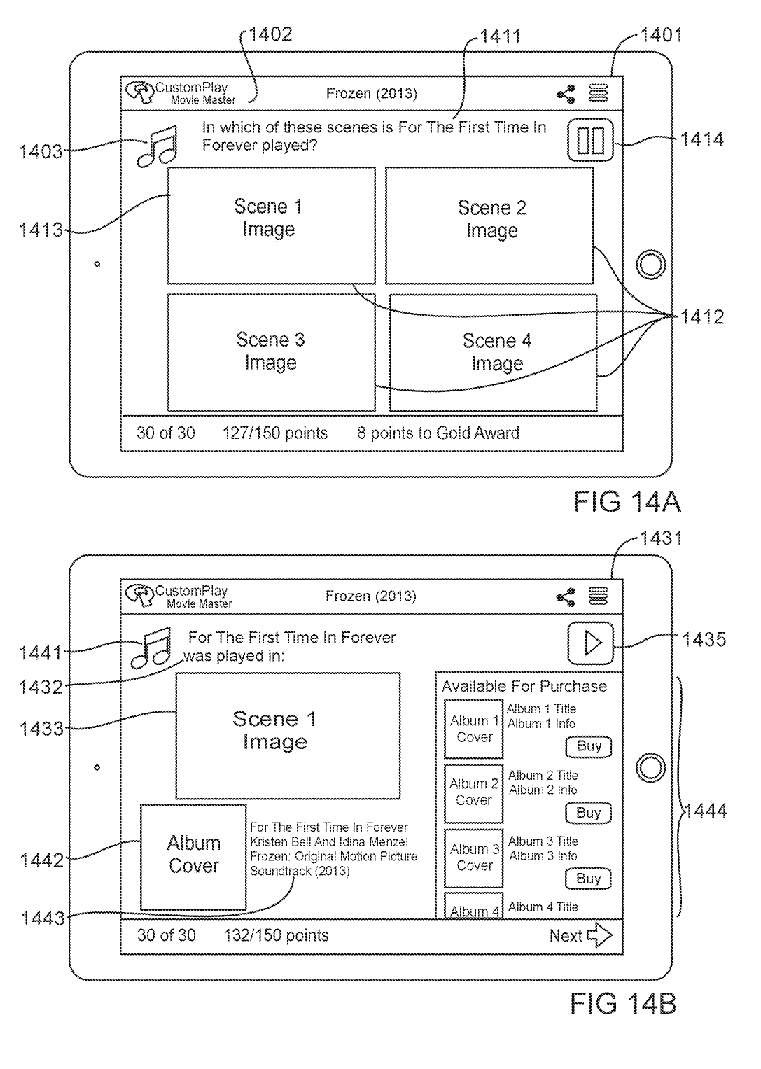

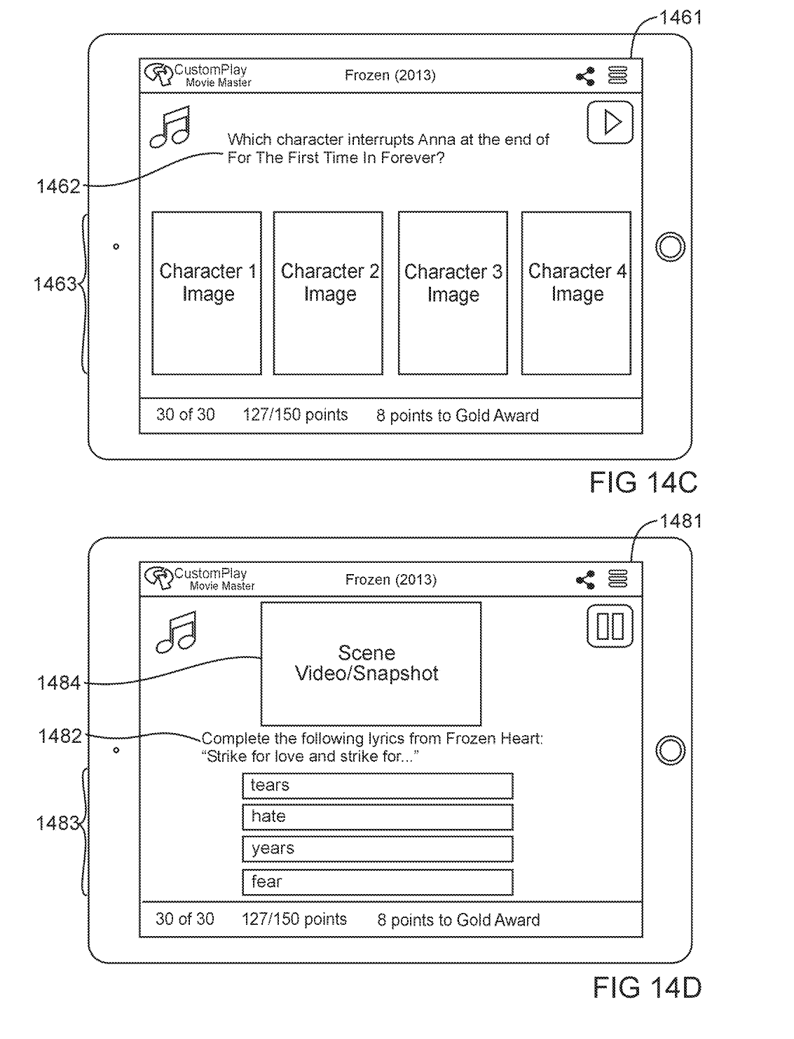

FIG. 14A is an illustration of an application interface displaying information and features of a music question in the Movie Master game. This interface screen 1401 identifies the Movie Master game as the active function 1402, and identifies the function being introduced 1403 (e.g., an icon associated with the Music function) and that is the source of the question. In this exemplary embodiment of a music question, the Movie Master game question is usually a rephrasing of source information provided in the Music function's Sync on-demand and Lists modes. For example, in the Movie Master game, the music question 1411 (“In which of these scenes is For The First Time In Forever played?”) is based on information supporting the Music function which identifies the musical item and the location in the movie in which the musical item is played. In this exemplary embodiment, the user is asked to select among the four images 1412 (e.g., video frames) of scenes depicted within the movie. One image 1413 of the four images corresponds to the correct answer.

In a novel embodiment, the interface screen 1401 provides a music Play/Pause icon button 1414 which enables a user to pause/play a sample of the musical item. With that object, the information supporting the Music function comprises a linkage to a website/server providing an adequate sample of the musical item (e.g., iTunes). Advantageously, responsive to system and/or user preestablished preferences, the playing of the musical item is automatically enabled contemporaneously with an initial display of the question 1411. The user, then, as illustrated 1414, has the option to pause/stop the playing of the musical item. In those instances when the correct answer to the question is provided by an otherwise playable portion of the musical item, the playing of the musical item is disabled, and the music Play/Pause icon button 1414, which generally enables a user to pause/play at least a portion or sample of the musical item, would not be displayed.

FIG. 14B is an illustration of an application interface displaying information and features of the Music function within the Movie Master game. As in other exemplary illustrations, the interface screen 1431 identifies the Movie Master game as the active function, and confirms the correct answer by, for example, including introductory text 1432 (e.g., “For The First Time In Forever was played in:”) and identifying the scene in which the musical item was played 1433 (e.g., a video/snapshot of Scene 1). The interface screen 1431 also illustrates that the playing of the musical item is in the pause state (i.e., the Play/Pause icon toggle button 1435 displays a Play icon).

Advantageously, in a preferred embodiment, the related Music function is identified 1441 (e.g., Music function icon), and additional information introducing features of the Music function are provided. The additional information includes, for example, an Album Cover illustration/photo 1442 of the album that includes the musical item; and information relating to the musical item and/or the album 1443 (e.g., musical item title: “For The First Time In Forever”, artists: “Kristen Bell And Idina Menzel”, album title: “Frozen: Original Motion Picture Soundtrack”, and release year: “2013”). The additional information may also include purchase information 1444 relating to the musical item featured in the music question. The purchase information may comprise, for example, and identification (e.g., album cover, album title, and information) of the various albums that include the musical item, as well as one or a plurality of purchase icon buttons for each musical album. Purchase information need not be limited to purchase of an album or musical item. Subscription services may also be identified.

An advantageous feature of the Movie Master game is that the variety of the formats that the questions and answers can take enables avoiding repetition of presentation. Additionally, the potential to use any one of a plurality of formats provides flexibility as to the types of questions that may be asked and the fact that a number of different questions may be asked that are drawn to the same musical item. Accordingly, a function's question and answer format is not limited to the specific formats illustrated for that function.

The format of the answers in the Movie Master question for the Music function has been illustrated in FIG. 14A as four images (e.g., video frames) of scenes depicted within the movie. However, in those instances, where the musical question relates to a character, the user may be asked to select among the depictions of four character video/snapshots depicted within the movie. FIG. 14C is an illustration of an application interface displaying an alternate format for a music question in the Movie Master game. In this exemplary interface screen embodiment 1461 of a music question, the Movie Master game question 14622 is in a written format (e.g., “Which character interrupts Anna at the end of For The First Time In Forever?”. However, the presentation of the answers implements a format often used with respect to the Who function (e.g., identification of a character). In such an answer format, the user is asked to select among the depictions of four character video/snapshots 1463 depicted within the movie. The interface screens providing supplementary information or displaying information and features of a function would be responsive to the question and answer format implemented. For example, in the case that the answers are images of characters, the previously illustrated introductory text and scene image would be replaced with appropriate introductory text and a correct character image. The question and answer format utilizing depictions of four character video/snapshots may be additionally implemented by a number of Functions such as the Quotes function.

Generally, as in other exemplary embodiments, while the use of video/snapshots is more advantageous in the context of a movie related application, in a simple embodiment the user may be asked to select among four written answers. FIG. 14D is an illustration of an application interface displaying an additional alternate format for a music question in the Movie Master game. In this exemplary interface screen embodiment 1481 of a music question, the Movie Master game question 1482 and answers 1483 are in a written format. For example the written question 1482 asks the user to: “Complete the following lyrics from Frozen Heart: ‘Strike for love and strike for . . . ’”, and provides the following four optional written answers 1483: “tears”, “hate”, “years”, and “fear”. A scene video/snapshot 1484 may also be included to provide context for the question. A written answers format may be additionally implemented by a number of Functions such as the Plot Info, Shopping, Trivia, Vehicles, and Weapons functions.

Among the number of different embodiment that may be implemented, in a preferred embodiment, a system, such as a remote web server that processes API requests from a user's device, a smartphone, a tablet, and a computing communications device performs the steps of: displaying a movie related question derived from information of a movie related function of a plurality of movie related functions of a movie application, and providing for multiple tries for a user to select a correct answer from a displayed plurality of answers associated with the movie related question; awarding points responsive to a number of tries required by the user to select a correct answer from the displayed plurality of answers associated with the movie related question; displaying, subsequent to receiving a user's answer selection in response to the displayed plurality of answers associated with the movie related question, information from the movie related function; displaying, responsive to a user's request, a subsequent movie related question derived from information of another movie related function of the plurality of movie related functions of the movie application, and providing for multiple tries for a user to select a correct answer from a displayed plurality of answers associated with the subsequent movie related question; awarding points responsive to a number of tries required by the user to select a correct answer from a displayed plurality of answers associated with the subsequent movie related question; and displaying, subsequent to receiving a user's answer selection in response to the displayed plurality of answers associated with the subsequent movie related question, information from the another movie related function.

In such an embodiment, a movie related function may relate to, for example, locales depicted within the movie, identifications of weapons depicted within the movie, moral dilemmas depicted within the movie, and to food recipes inspired by depictions within the movie; the displaying of information from the movie related function further comprises displaying a feature of the movie related function; the displaying of information from the another movie related function further comprises displaying a feature of the another movie related function; and/or the displayed plurality of answers consists of a standardized number of answers irrespective of the information of the movie related function from which the movie related question is derived.

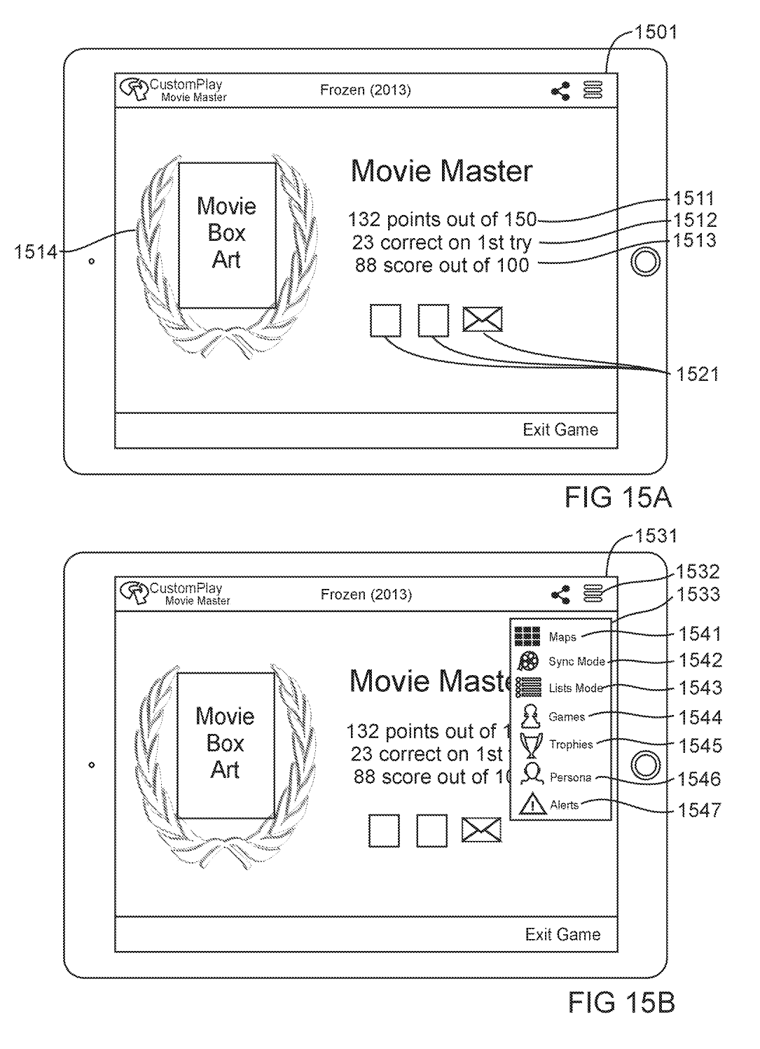

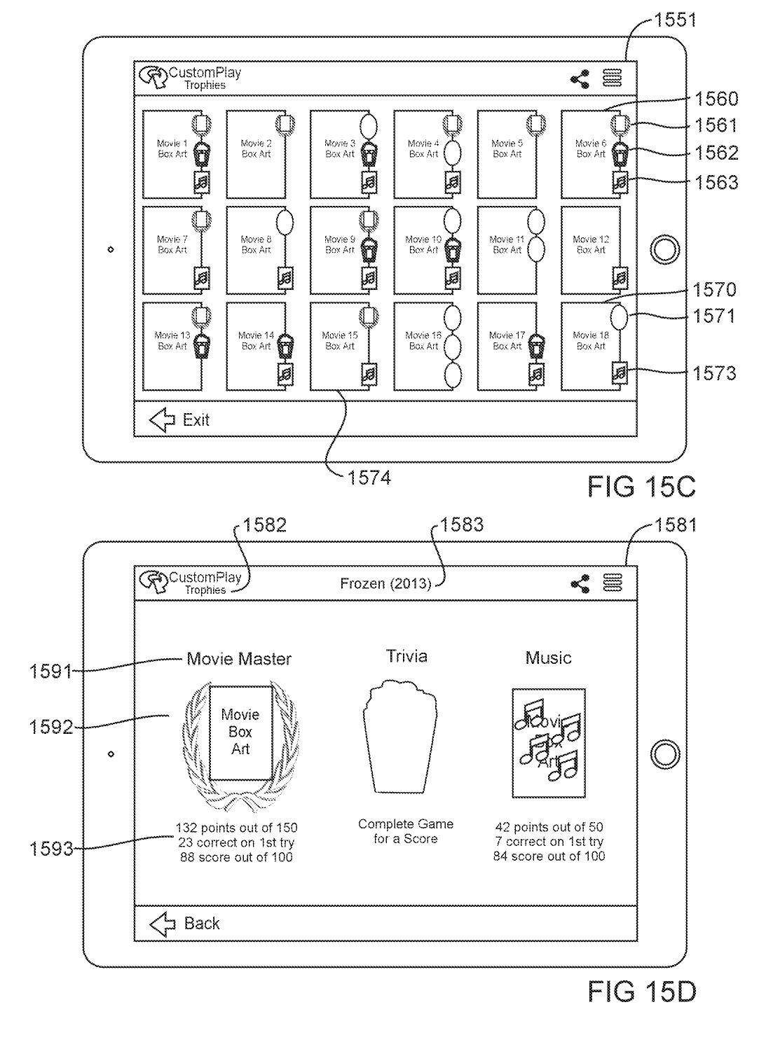

Upon a user completing the questions in the Movie Master game, the user is provided information that is responsive to how the user answered the questions. FIG. 15A is an illustration of an application interface screen displaying the score features of the Movie Master game. As in other exemplary illustrations, the interface screen 1501 identifies the Movie Master game as the active function, and, in this exemplary embodiment, provides information that is responsive to how the user answered the questions such as the number of points awarded out of a total number of possible points 1511 (e.g., “132 points out of 150”), the number of questions answered correctly on a first try 1512 (e.g., “23 correct on 1rst try”), and a score converting the awarded points to a percentage of total potential points 1513 (e.g., “88 score out of 100”) Innovatively, scoring statistics such as the function name, the number of questions for that function, and the number correct on a first try, are also provided for each of the individual functions (e.g., “Shopping 3 out of 4 on a first try”).

Based on a user's score a responsive award 1514 may be provided. For example, a bronze award is displayed for a score of 70 to and including 79, a silver award for a score of 80 to an including 89, a gold award for a score of 90 to 99, and gold and platinum award for a perfect score of 100. The application interface screen includes dedicated social media buttons (e.g., Facebook, Twitter, and Email) 1521 that provide efficient posting and communications capabilities that are responsive to, in this example, the Movie Master Game score 1513 and award 1514. For example, activation of the Facebook icon would enable the applications automated preparation of a posting of the score 1513, an image of the award 1514, additional information such as the source of the game, and links.

FIG. 15B is an illustration of an application interface screen displaying a pull down menu of the principal broad functions and modes of the application. In this exemplary illustration, following a user activating the pull down menu icon button 1532, the application interface screen 1531 superimposes a pull down menu 1533 on top of the current screen display, in this example the Movie Master award page for a movie. The pull down menu provides access to, for example, the principal broad functions and modes of the application, such as the movie map 1541 (screen depicting movie box arts corresponding to the available movie maps for the application), the Sync mode 1542, the Lists Mode 1543, the Games 1544, the Trophies 1545, the Persona 1546, and the Alerts 1547 application screens. Selecting the Trophies' icon causes a display of a user's trophy case.

FIG. 15C is an illustration of an application interface screen displaying a user's movie related trophy case. In this exemplary illustration, following a user activating the pull down menu icon button and activating the Trophies icon button, the interface screen 1551 displays a collection of movie box arts for which the user has played at least one of the games (e.g., Movie Master, Trivia, and Music games). Superimposed on each box art is a depiction of the award that the user may have obtained. For example, associated with the movie 6 box art 1560, is a representation of the Movie Master award 1561, the Trivia award 1562, and the Music award 1563. In the event that a user has attempted a game but has failed to achieve the score necessary for an award, then an appropriate symbol is superimposed on the movie box art. For example, the illustration with respect to the Movie 18 box art 1570, the empty elliptical symbol 1571 indicates that the user has played the Trivia game but has failed to score the necessary points, while the user has played the Music game and has scored sufficient point for an award 1573.

While not depicted in the exemplary illustration, in a preferred embodiment, each award depicted will indicate (e.g., color) the appropriate level of the award (e.g., bronze, silver, gold, or gold/platinum). A user may obtain additional information relating to the awards for a specific movie by selecting a corresponding box art 1574. Following a user selection of a box art icon 1574 (e.g., Frozen movie box art), a screen is activated that displays a responsive award information.

FIG. 15D is an illustration of an application interface screen displaying a user's awards for a movie. The interface screen 1581 identifies Trophies as the active function 1582, identifies the movie (e.g., “Frozen”) 1583 for which trophy data is provided, and displays, for example, the name of the game 1591 (e.g., Movie Master), displays the award 1592 (e.g., Silver Movie Master award), and provides game statistics 1593 (e.g., “132 points out of 150, 23 correct on 1st try, 88 score out of 100”). Advantageously, a game's scoring is standardized as a percent to facilitate relative comparisons of the applications games with different potential point totals. Game statistics may also comprise selected friends comparable statistics, as well as community averages, quartile, and highest scores.

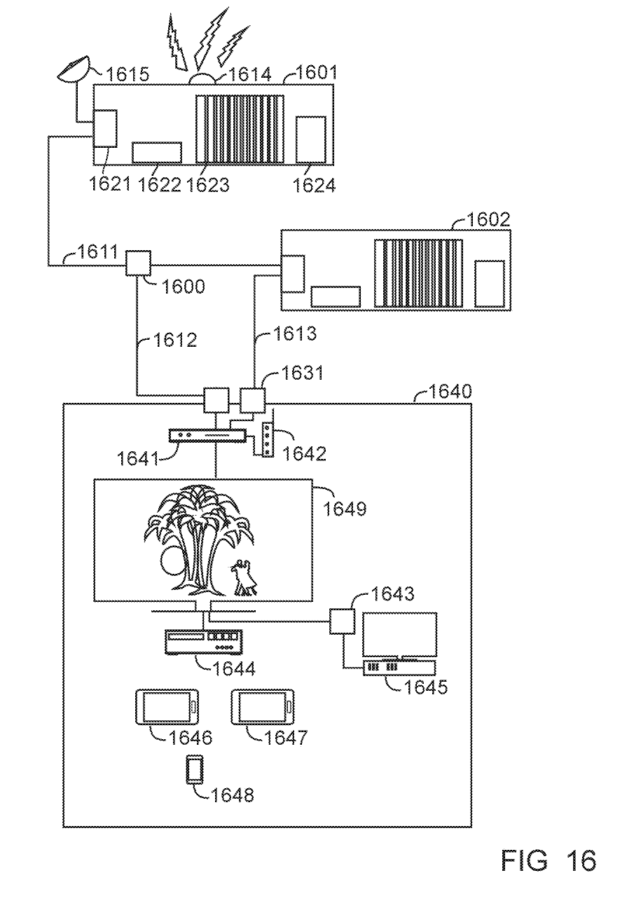

FIG. 16 is a schematic diagram of a communications, systems, and devices infrastructure. In a preferred embodiment of the communications, systems, and devices infrastructure, participants comprise any number of movie 1601 and/or information 1602 providers, and end-users systems 1640. A provider of movie and/or information 1601-1602 is not limited to any combination of movie and/or information services; and the services, while complementary, may be proprietary, exclusive, and independent of the services of other providers. Each participant, whether principally a provider 1601-1602 or end user 1640 is able to retrieve and transmit movie and/or information from and to any other participant.

The delivery of movie and services are herein intended to be deployable by a variety of possible communications systems, networks, infrastructures, computer and server networks, and system configurations. FIG. 16 suggests a plurality of systems, networks, infrastructures, and system configurations that may be implemented. Shown are wired and non-wired communications networks using, for example, one or a hybrid combination of fiber optic 1611, coaxial cable 1612, twisted copper wire 1613, cellular 1614, and/or satellite 1615.

A movie provider, for example 1601, comprises: i) communications technologies 1611 for establishing a plurality of movie and communications streams to a plurality of end-users 1640 to enable the uploading and/or downloading of information and/or movie content; ii) processing hardware and software 1622 for retrieving an end user's movie preferences, content preferences, function preferences and requests, search terms and search requests, and for processing the user's movie preferences, content preferences, function preferences and requests, in-movie services, synchronization data, search terms and search requests, and supporting the game functions; iii) mass storage random access memory devices 1623 for storing and retrieving movie maps and information supporting the application functions such as the Dilemma, Movie Master, and Music games, and/or for storing a moviebase comprising a plurality of any combination of movies, information supporting the application functions and services, synchronization data, and/or information; and iv) processing hardware and software 1624 for maintaining accounting and support services in connection with movie and/or information services provided.

Movie providers may be further categorized according to the functions served and/or the extent and character of the information and moviebase maintained. Movie services providers 1601, e.g., a cable companies, may be capable of providing a greater variety of services than for example information providers 1602, e.g., websites. Movie and information services available over the internet are suggestive of the wide range of multimedia and information configurations that are possible.

A user's system access to the resources of a movie services provider 1601-1602 need not be direct. A requested movie may be streamed or downloaded, in real time or non-real-time, to a services provider that may be more economically accessible to the intended user. Within the network 1600, some movie services provider may not directly provide any services to users, but act as centralized movie originators or depositories for other services providers.

In one of many possible embodiments, an end-user movie system infrastructure 1640 acquires access to the network 1600 and the various services providers 1601-1602 via a communications device 1631, e.g., cable distribution box, satellite dish. An end-users movie system infrastructure 1640 comprises a great variety of systems, communications devices, computing devices, and screens 1641-1649 capable of processing information and instructions executable by a processor and capable of performing the application, functions, and features disclosed herein. Principally communications devices include, for example, a modem 1641, e.g., cable modem; an internal communications device 1642, e.g., wired and wireless router; and a network/wireless extender 1643. The end-user's communication interfaces such as Wi-Fi, Ethernet, cellular, 4G LTE, HDMI, Optical, G.hn, and USB facilitate communications among the end-users various computing/communicating systems and multi-screen combinations 1644-1649, which include, for example, set top box 1644, e.g., cable box; PC/monitor 1645; tablets 1646-1647; smartphone 1648; and television 1649. An end user system may be generally categorized as principally a communications device, a computing device, or a screen. However, systems, such as tablets 1646-1647, smartphones 1648, and portable/notebook computers 1645, comprise all three functions and are capable of performing the application's methods and steps. Further, a television system 1649 may include computing, storage, and communications capabilities that may otherwise be separately provided in a set-top box or television media accessory 1644.

Communications may be established by any of a variety of wired or wireless communications networks including, for example, Wi-Fi and cellular (e.g., 4G LTE) communications networks. Thus, a computing system need not be directly or indirectly connected by wire to a screen 1649. For example, a computing device 1645 may be connected to a second screen 1649 via a communications port 1643. The communications port may be of varying degrees of intelligence and capabilities, it may serve to boost or manage the signal, or have no other purpose than to serve as a convenient outlet in which to plug and unplug devices.

The particular location of an end-users systems, devices, screens, subsystems, or components, whether within the immediate boundaries of a residence or the particular location, are not limited herein to any particular arrangement. A variety of configurations are possible to meet the various needs of the end user at any particular time. In a preferred embodiment an end-user configuration comprises a primary display system 1649, one or multiple secondary display systems such as a personal computer or portable computer 1645, tablets 1646-1647, and/or smartphone 1648.

An application software appropriate for the communications infrastructure may reside directly or indirectly in a primary display system, secondary display system (e.g., device), and/or in separate system in communication with the primary display system and secondary display system. In stand alone modes or function of the application, a secondary display system (e.g., second screen device) operates as the primary system.

Multi-system combinations include, for example, television 1649 and smartphone 1648, pc/laptop 1645 and smartphone 1648, television 1649 and pc/laptop 1645, and television 1649 and multiple tablets 1646-1647. Multi-system combinations need not be limited to a primary system and a secondary system. For example, a second system such as a tablet 1646 may provide a second system experience with respect to a primary system such a television 1649, and with respect to another second system such as a second tablet 1647.

Multi-system usage modes may be broadly categorized as disruptive (e.g., multi-tasking unrelated content) or complementary; sequential (e.g., usage of a primary system is followed by usage of a second system) or simultaneous; planned (e.g., expected usage of a second system as part of the viewing of the content on a primary system) or spontaneous; and/or dependent (e.g., highly integrated with content on the primary system) or independent. However, a multi-system usage may be, for example, both disruptive and complementary. Disruptive, for example, in the sense that the linear movie experience is interrupted, while at the same time complementary in the sense that information is provided that the user would deem advantageous in enhancing the movie experience. In the Sync mode embodiments a second system's user interface provides interactive capabilities that are highly tailored and synergistically integrated with the specific content displayed on a primary system. By contrast, in Lists mode and in certain Games mode embodiments a second system's software application (e.g., iPad application) provides capabilities that are independent of a primary system. Further, Lists mode and Games mode embodiments do not limit where a user may enjoy the application various functions.

Implementation of the novel features detailed herein are not confined to the communications infrastructure, services providers, and end-user systems detailed with respect to FIG. 16. As is detailed in the '325 publication, a great many alternate or complementary systems, devices, components, elements, and services may be utilized.

It is noted that while certain exemplary embodiments are detailed, directly or by incorporation, the inventions are not limited to the exemplary information or features utilized in any mode, function, and/or specific embodiment. An advantage of a particular embodiment, mode, function, feature, information, or element is not necessarily limited to that particular embodiment, mode, function, feature, information, or element. While most of the FIGS illustrate the use of a tablet (e.g., an iPad), an alternate preferred embodiment is based on the use of a smartphone (e.g., iPhone) which has downloaded, in a conventional manner, the application comprising substantially all of the features of each function. A remote web server that processes API requests from a user's device, a website server, a smartphone, a tablet, a hybrid, a laptops, and a computing communications device, each comprises the necessary processing, memory, and communications capabilities required to fully operate the application's various functions and methodologies disclosed herein.

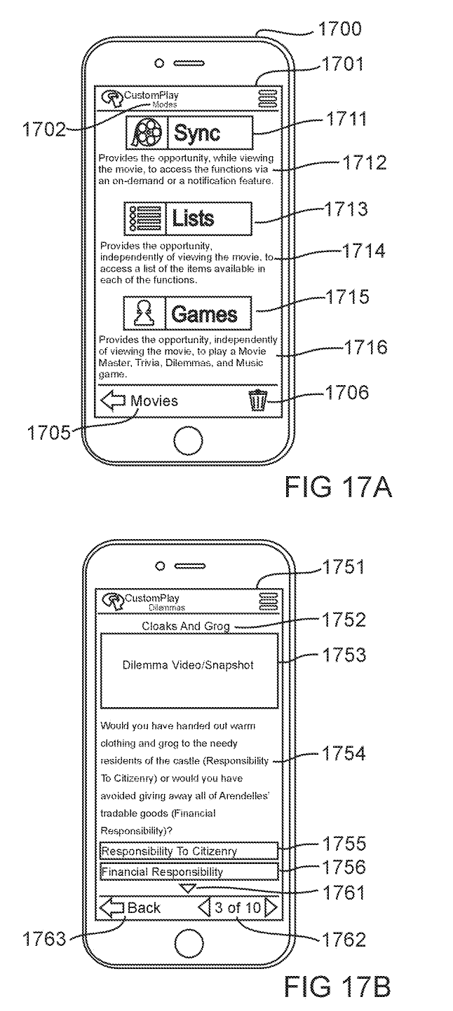

FIG. 17A is an exemplary illustration of an iPhone implementation of the application interface enabling the selection of the Sync, Lists, and Games modes. A comparison with its iPad counterpart illustrated in FIG. 1 demonstrates that this class of screens can be readily accommodated by dropping the display of the movie box art which serves principally a decorative function in the iPad exemplary embodiment.

In the exemplary embodiment illustrated in FIG. 17A, the application is downloaded and installed on an iPhone device 1700. This interface screen 1701 identifies the Mode selection as the active function 1702, displays a selection button for the Sync mode 1711, the Lists mode 1713, and the Games mode 1715, and a corresponding explanations for the Sync mode 1712, the Lists mode 1714, and the Games mode 1716. The interface screen 1701 also enables returning to the movies' map selection screen 1705 and deleting the current movie map 1706.

FIG. 17B is an exemplary illustration of an iPhone implementation of the application interface displaying information and features of a dilemma question available in Lists mode. A comparison with its iPad counterpart illustrated in FIG. 7B demonstrates that this class of screens can be readily accommodated by adjusting the layout and placement of the features of the function and by taking advantage of vertical scrolling capabilities of, for example, an iPhone.

The features of the Dilemma function included in this exemplary embodiment 1751 comprises a title 1752 for a moral dilemma depicted within the movie, a dilemma video/snapshot 1753 is made available to provide context for a dilemma question identifying the two moral principles that are in conflict 1754, and first moral principle labeled button 1755 and second moral principle labeled button 1756. In this exemplary embodiment, a vertical icon 1761 is displayed indicating that additional information is available by swiping down. The additional information comprises, for example, a general dilemma question, and the yes/no buttons. As is suggested by the illustrated left and right arrows and the identification of the current dilemma and the total number of dilemmas in the movie (e.g., 3 of 10) 1762, a user need not return to the List screen to access a preceding or following dilemma. An iPhone embodiment, for example, enables swiping among the presentation of dilemma questions. A back arrow icon button 1763 permits returning to a list selection screen.

Further, as the exemplary embodiments demonstrate, a feature, structure, method, or step that is disclosed with respect to a certain function may be similarly implemented in another function. For example, a gaming format analogous to one of the Recipe function game formats may be implemented with respect to the Vehicles and Weapons functions. Specifically, a user is asked to match each of a plurality of movie box arts (e.g., “Predator”) with a corresponding image of a weapon from a plurality of images of noteworthy or iconic weapons (e.g., “Old Painless”) depicted within the movie. With respect to the Quotes function, for example, a user is provided a set of quotes and a set of video frames from within the movie and is invited to match each of the quotes with a corresponding scene or character. Each of the quotes is selected from a different scene within the movie to avoid potential duplication. Alternatively, a question pairing a single quote and a set of images is sequentially presented after the user has responded to a previous question pairing a single quote and a set of images.

Many variations of the elements included in a particular embodiment are possible by way of permutation, combination, substitution, deletion, and/or additions. A function may be enhanced by the addition of features and information elements (e.g., segment definitions, frame identification, play position identification, image and thumbnail identifiers, write-ups, and linkages) detailed with respect to another function.

The information supporting functions or features of a function is not limited to the information explicitly disclosed herein. The information supporting a specific function or specific feature of a function also comprises the information that is implicit, that is logically necessary to support the feature, and/or that is analogous to disclosed information supporting a different function or a different feature of a function. A movie map addressing the functions and features illustrated or detailed herein comprises a great database of additional information that may be mined to support the various functions, features, and playback functions.

The teachings disclosed herein, directly and indirectly by, for example, incorporation, are intended to show a variety of architectures, services, capabilities, systems, methods, and inventive elements which are combined and may be combined to suit particular embodiments. While an object of incorporation is to provide additional detail explanation, the synergies among and between the various inventive elements is a significant feature of and object of incorporation. The incorporation by reference at a specific place within the specification is not intended to limit the extent to which the reference is incorporated, or the manner in which it may be integrated. Where a teaching may be deemed to be at cross purposes, or otherwise incompatible, with some other teaching, it ought to be understood as a possible alternative to be utilized as a particular preferred embodiment may require.

While elements of the inventions have been detailed in conjunction with specific embodiments thereof, it is evident that many alternatives, modifications and variations are possible and will be apparent to those skilled in the art in light of the foregoing descriptions. Accordingly, it is intended to embrace all such alternatives, modifications, variations, and combinations as fall within the spirit and broad scope of the specification. The teachings that have been cited and incorporated herein are offered by way of example, and not limitation, of the underlying foundation of knowledge and skill that is available to a person of ordinary skill in the art. Many of the features, components, and methods found in the art may be incorporated, as suggested herein, in a preferred embodiment; and since other modifications and changes varied to fit particular requirements and environments will be apparent to those skilled in the art, the inventions are not limited to the embodiments set forth or suggested herein. It is to be understood that the inventions are not limited thereby. It is also to be understood that the specific details shown are merely illustrative, and that the inventions may be carried out in other ways without departing from the broad spirit and scope of the specification.

What is claimed is:

1. A system capable of performing the steps of:
displaying a plurality of moral dilemma questions, each of which is associated with a plurality of displayed answers;
receiving a user's answer selections in response to the displayed plurality of moral dilemma questions;
comparing the user's answer selections against information associating at least one answer to a moral dilemma question with at least one of a plurality of movie characters; and
identifying, responsive to the comparing, a movie character that is matched to the user's answer selections.

2. The system of claim 1, wherein the displaying of the moral dilemma questions is in synchronization with a playing of a movie from which the moral dilemma questions are derived.

3. The system of claim 1, wherein the identifying comprises identifying a movie character that is positively matched to the user's answer selections and identifying a movie character that is negatively matched to the user's answer selections.

4. The system of claim 1, information associating at least one answer to a moral dilemma question with at least one of a plurality of movie characters comprises associating a comparative value.

5. The system of claim 1, wherein the system capable of performing the steps is selected from the group consisting of a remote web server that processes API requests from a user's device, a smartphone, a tablet, and a computing communications device.

6. A system capable of performing the steps of:
displaying a plurality of moral dilemma questions, each of which is associated with a plurality of displayed answers;
receiving a user's answer selections in response to the displayed plurality of moral dilemma questions;
combining the received user's answer selections with a previously received set of user's answer selections;
comparing the combined user's answer selections against a moral dilemma profile of each of a plurality of movie characters; and
identifying, responsive to the comparing, a movie character that is matched to the combined user's answer selections.

7. The system of claim 6, wherein the plurality of displayed answers comprises a plurality of moral principles.

8. The system of claim 6, wherein the plurality of displayed answers comprises a plurality of standardized moral principle descriptors; and wherein a user's answer selections is a user's moral principle descriptor selections.

9. The system of claim 6, wherein the displaying of the moral dilemma questions is in synchronization with a playing of a movie from which the moral dilemma questions are derived.

10. The system of claim 6, wherein the previously received set of user's answer selections was responsive to a set of moral dilemma questions derived from a movie that is different than the movie from which the displayed plurality of moral dilemma questions are derived.

11. The system of claim 6, wherein the identifying comprises identifying a movie character that is positively matched to the user's answer selections and identifying a movie character that is negatively matched to the user's answer selections.

12. The system of claim 6, wherein a moral dilemma profile of each of the plurality of movie characters comprises a plurality of moral dilemma descriptors each associated with a comparative value.

13. The system of claim 6, wherein the system capable of performing the steps is selected from the group consisting of a remote web server that processes API requests from a user's device, a smartphone, a tablet, and a computing communications device.

14. The system of claim 6, wherein the previously received set of user's answer selections was responsive to a set of moral dilemma questions derived from a movie that is different than the movie from which the displayed plurality of moral dilemma questions are derived; and wherein a moral dilemma profile of each of the plurality of movie characters comprises a plurality of moral dilemma descriptors each associated with a comparative value.

15. A system capable of performing the steps of:
displaying a plurality of moral dilemma questions, each of which is associated with a plurality of moral principles;
receiving a user's moral principle selections in response to the displayed plurality of moral dilemma questions;
comparing the user's moral principle selections against information associating at least one moral principle with at least one of a plurality of movie characters; and
identifying, responsive to the comparing, a movie character that is matched to the user's moral principle selections.

16. The system of claim 15, wherein the displaying of the moral dilemma questions is in synchronization with a playing of a movie from which the moral dilemma questions are derived.

17. The system of claim 15, wherein the plurality of moral principles are standardized moral principle descriptors; and wherein the user's moral principle selections are responsive to the standardized moral principle descriptors.

18. The system of claim 15, wherein the information associating at least one moral principle with at least one of a plurality of movie characters, associates a moral dilemma descriptor and a comparative value.

19. The system of claim 15, wherein the system capable of performing the steps is selected from the group consisting of a remote web server that processes API requests from a user's device, a smartphone, a tablet, and a computing communications device.

20. The system of claim 15, wherein the plurality of moral principles are standardized moral principle descriptors; wherein the user's moral principle selections are responsive to the standardized moral principle descriptors; wherein the movie characters are selected for their distinguishing moral traits; and wherein the information associating at least one moral principle with at least one of a plurality of movie characters, associates a moral dilemma descriptor and a comparative value.
